(19) United States
(12) Patent Application Publication
(10) Pub. No.: US 2025/0126618 A1
(43) Pub. Date: Apr. 17, 2025

(54) CONTROL CHANNEL ADJUSTMENT FOR CONNECTED STATE

(71) Applicant: QUALCOMM Incorporated, San Diego, CA (US)

(72) Inventors: Mungal Singh DHANDA, Slough (GB); Alberto RICO ALVARINO, San Diego, CA (US); Umesh PHUYAL, San Diego, CA (US); Bharat SHRESTHA, San Diego, CA (US); Venkateswarlu BANDARU, Hyderabad (IN)

(21) Appl. No.: 18/684,608

(22) PCT Filed: Oct. 20, 2022
(86) PCT No.: PCT/US2022/078440

§ 371 Date: Feb. 16, 2024

(30) Foreign Application Priority Data
Oct. 22, 2021 (IN) 202141048168

(51) Int. Cl. H04W 72/23; H04L 1/08; H04W 24/08; H04W 72/0446

(52) U.S. Cl. CPC H04W 72/23; H04L 1/08; H04W 24/08; H04W 72/0446

(57) ABSTRACT

Methods, systems, and devices for control channel adjustment for a connected state are described. In some examples, a user equipment (UE) may receive a control message from a base station, the control message indicating a number of repetitions for a downlink control channel (e.g., a narrowband physical downlink control channel (NPDCCH)) for the UE. In such examples, the UE may be in a connected state and may receive an indication to adjust the number of repetitions for the downlink channel for the UE from a first number of repetitions to a second number of repetitions. In some examples, the UE may monitor one or more transmission time intervals (TTIs) for the downlink control channel for the UE based on the second number of repetitions, where a number of the one or more TTIs may correspond to the second number of repetitions.

### CROSS REFERENCE

The present Application is a 371 national stage filing of International PCT Application No. PCT/US2022/078440 by DHANDA et al. entitled “CONTROL CHANNEL ADJUSTMENT FOR CONNECTED STATE,” filed Oct. 20, 2022; and claims priority to Indian Patent Application No. 202141048168 by DHANDA et al., entitled “CONTROL CHANNEL ADJUSTMENT FOR CONNECTED STATE,” filed Oct. 22, 2021, each of which is assigned to the assignee hereof, and each of which is expressly incorporated by reference in its entirety herein.

### FIELD OF TECHNOLOGY

The following relates to wireless communications, including control channel adjustment for connected state.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, radio link failure (RLF) may occur due to inefficiencies associated with a control channel configuration. For example, a UE may detect an RLF if the UE has difficulty receiving and successfully decoding a signal from the base station, such as a control channel or reference signal.

### SUMMARY

The described techniques relate to improved methods, systems, devices, and apparatuses that support control channel adjustment for connected state. Generally, the described techniques provide for a user equipment (UE) in a connected state (e.g., with a network device) to receive an adjustment indication, configuring the UE to monitor a control channel according to a number of repetitions than a number of repetitions previously configured at the UE. For example, the UE may receive a control message from a network device, the control message indicating a number of repetitions for a downlink control channel for the UE. In such examples, the UE may be in a connected state and may receive an indication to adjust the number of repetitions for the downlink channel for the UE. In some examples, the UE may monitor one or more transmission time intervals (TTIs) for the downlink control channel for the UE based on the adjusted number of repetitions.

A method for wireless communications at a UE is described. The method may include receiving a control message from a network device, the control message indicating a number of repetitions to be transmitted to the UE via a downlink control channel, receiving, at the UE in a connected state, an indication to adjust the number of repetitions to be transmitted to the UE via the downlink control channel from a first number of repetitions to a second number of repetitions, and monitoring, by the UE in the connected state, one or more TTIs for the downlink control channel based on the second number of repetitions, where a number of the one or more TTIs corresponds to the second number of repetitions.

An apparatus for wireless communications at a UE is described. The apparatus may include a processor, memory coupled with the processor, and instructions stored in the memory. The instructions may be executable by the processor to cause the apparatus to receive a control message from a network device, the control message indicating a number of repetitions to be transmitted to the UE via a downlink control channel, receive, at the UE in a connected state, an indication to adjust the number of repetitions to be transmitted to the UE via the downlink control channel from a first number of repetitions to a second number of repetitions, and monitor, by the UE in the connected state, one or more TTIs for the downlink control channel based on the second number of repetitions, where a number of the one or more TTIs corresponds to the second number of repetitions.

Another apparatus for wireless communications at a UE is described. The apparatus may include means for receiving a control message from a network device, the control message indicating a number of repetitions to be transmitted to the UE via a downlink control channel, means for receiving, at the UE in a connected state, an indication to adjust the number of repetitions to be transmitted to the UE via the downlink control channel from a first number of repetitions to a second number of repetitions, and means for monitoring, by the UE in the connected state, one or more TTIs for the downlink control channel based on the second number of repetitions, where a number of the one or more TTIs corresponds to the second number of repetitions.

A non-transitory computer-readable medium storing code for wireless communications at a UE is described. The code may include instructions executable by a processor to receive a control message from a network device, the control message indicating a number of repetitions to be transmitted to the UE via a downlink control channel, receive, at the UE in a connected state, an indication to adjust the number of repetitions to be transmitted to the UE via the downlink control channel from a first number of repetitions to a second number of repetitions, and monitor, by the UE in the connected state, one or more TTIs for the downlink control channel based on the second number of repetitions, where a number of the one or more TTIs corresponds to the second number of repetitions.

Some examples of the method, apparatuses, and non-transitory computer-readable medium described herein may further include operations, features, means, or instructions for transmitting a limit indicator for the downlink control channel indicating that a control channel limit associated with the downlink control channel may have been reached, where the indication to adjust the number of repetitions may be in response to the limit indicator.

Some examples of the method, apparatuses, and non-transitory computer-readable medium described herein may further include operations, features, means, or instructions for receiving, from the network device, a channel quality threshold associated with the downlink control channel, where the limit indicator may be transmitted based on a channel quality associated with the downlink control channel crossing the channel quality threshold.

In some examples of the method, apparatuses, and non-transitory computer-readable medium described herein, transmitting the limit indicator may include operations, features, means, or instructions for transmitting the limit indicator in a control element of an uplink message, where the control element may be configured for limit indicator reporting.

In some examples of the method, apparatuses, and non-transitory computer-readable medium described herein, transmitting the limit indicator may include operations, features, means, or instructions for transmitting the limit indicator in a control element of an uplink message, where the uplink message includes a downlink channel quality report.

In some examples of the method, apparatuses, and non-transitory computer-readable medium described herein, the limit indicator may be a request to adjust the number of repetitions to be transmitted to the UE via the downlink control channel.

In some examples of the method, apparatuses, and non-transitory computer-readable medium described herein, receiving the indication may include operations, features, means, or instructions for receiving the indication to adjust the number of repetitions by a step factor.

In some examples of the method, apparatuses, and non-transitory computer-readable medium described herein, receiving the indication may include operations, features, means, or instructions for receiving the indication to adjust the number of repetitions by a multiplication factor of the first number of repetitions.

In some examples of the method, apparatuses, and non-transitory computer-readable medium described herein, the multiplication factor may be from a set of defined multiplication factors.

In some examples of the method, apparatuses, and non-transitory computer-readable medium described herein, the multiplication factor may be from a set of multiplication factors received via broadcast signaling.

In some examples of the method, apparatuses, and non-transitory computer-readable medium described herein, receiving the indication may include operations, features, means, or instructions for receiving the indication to increase or decrease the number of repetitions, where the increase or decrease of the number of repetitions maintains a periodicity associated with the downlink control channel that corresponds to the first number of repetitions.

In some examples of the method, apparatuses, and non-transitory computer-readable medium described herein, receiving the indication may include operations, features, means, or instructions for receiving the indication to adjust the number of repetitions to be transmitted by the UE via an uplink control channel.

In some examples of the method, apparatuses, and non-transitory computer-readable medium described herein, receiving the control message may include operations, features, means, or instructions for receiving one or more parameters that indicate a period of the downlink control channel for the UE, the one or more parameters including a first parameter and a second parameter, the first parameter indicating the second number of repetitions to be transmitted to the UE via the downlink control channel and the second parameter indicating a starting TTI of the one or more TTIs.

In some examples of the method, apparatuses, and non-transitory computer-readable medium described herein, the second number of repetitions may be an integer multiple of the first number of repetitions.

In some examples of the method, apparatuses, and non-transitory computer-readable medium described herein, the control message may be received via radio resource control (RRC) signaling and the downlink control channel includes a physical downlink control channel (PDCCH).

A method for wireless communications at a network device is described. The method may include transmitting a control message to a UE, the control message indicating a number of repetitions for a downlink control channel for the UE, transmitting, to the UE in a connected state, an indication to adjust the number of repetitions to be transmitted to the UE via the downlink control channel from a first number of repetitions to a second number of repetitions, and transmitting, to the UE in the connected state, the downlink control channel in one or more TTIs according to the second number of repetitions.

An apparatus for wireless communications at a network device is described. The apparatus may include a processor, memory coupled with the processor, and instructions stored in the memory. The instructions may be executable by the processor to cause the apparatus to transmit a control message to a UE, the control message indicating a number of repetitions for a downlink control channel for the UE, transmit, to the UE in a connected state, an indication to adjust the number of repetitions to be transmitted to the UE via the downlink control channel from a first number of repetitions to a second number of repetitions, and transmit, to the UE in the connected state, the downlink control channel in one or more TTIs according to the second number of repetitions.

Another apparatus for wireless communications at a network device is described. The apparatus may include means for transmitting a control message to a UE, the control message indicating a number of repetitions for a downlink control channel for the UE, means for transmitting, to the UE in a connected state, an indication to adjust the number of repetitions to be transmitted to the UE via the downlink control channel from a first number of repetitions to a second number of repetitions, and means for transmitting, to the UE in the connected state, the downlink control channel in one or more TTIs according to the second number of repetitions.

A non-transitory computer-readable medium storing code for wireless communications at a network device is described. The code may include instructions executable by a processor to transmit a control message to a UE, the control message indicating a number of repetitions for a downlink control channel for the UE, transmit, to the UE in a connected state, an indication to adjust the number of repetitions to be transmitted to the UE via the downlink control channel from a first number of repetitions to a second number of repetitions, and transmit, to the UE in the connected state, the downlink control channel in one or more TTIs according to the second number of repetitions.

Some examples of the method, apparatuses, and non-transitory computer-readable medium described herein may further include operations, features, means, or instructions for receiving a limit indicator for the downlink control channel indicating that a control channel limit associated with the downlink control channel may have been reached at the UE, where the indication to adjust the number of repetitions may be in response to the limit indicator.

Some examples of the method, apparatuses, and non-transitory computer-readable medium described herein may further include operations, features, means, or instructions for transmitting, to the UE, a channel quality threshold associated with the downlink control channel, where the limit indicator may be received based on a channel quality associated with the downlink control channel crossing the channel quality threshold.

In some examples of the method, apparatuses, and non-transitory computer-readable medium described herein, receiving the limit indicator may include operations, features, means, or instructions for receiving the limit indicator in a control element of an uplink message, where the control element may be configured for limit indicator reporting.

Some examples of the method, apparatuses, and non-transitory computer-readable medium described herein may further include operations, features, means, or instructions for transmitting the limit indicator in a control element of an uplink message, where the uplink message includes a downlink channel quality report.

In some examples of the method, apparatuses, and non-transitory computer-readable medium described herein, the limit indicator may be a request to adjust the number of repetitions to be transmitted to the UE via the downlink control channel.

In some examples of the method, apparatuses, and non-transitory computer-readable medium described herein, transmitting the indication may include operations, features, means, or instructions for transmitting the indication to adjust the number of repetitions by a step factor.

In some examples of the method, apparatuses, and non-transitory computer-readable medium described herein, transmitting the indication may include operations, features, means, or instructions for transmitting the indication to adjust the number of repetitions by a multiplication factor of the first number of repetitions.

Some examples of the method, apparatuses, and non-transitory computer-readable medium described herein may further include operations, features, means, or instructions for transmitting a set of multiplication factors via broadcast signaling, where the multiplication factor may be from the set of multiplication factors.

In some examples of the method, apparatuses, and non-transitory computer-readable medium described herein, transmitting the indication may include operations, features, means, or instructions for transmitting the indication to increase or decrease the number of repetitions, where the increase or decrease of the number of repetitions maintains a periodicity associated with the downlink control channel that corresponds to the first number of repetitions.

In some examples of the method, apparatuses, and non-transitory computer-readable medium described herein, transmitting the indication may include operations, features, means, or instructions for transmitting the indication to adjust the number of repetitions to be transmitted by the UE via an uplink control channel.

In some examples of the method, apparatuses, and non-transitory computer-readable medium described herein, transmitting the control message may include operations, features, means, or instructions for transmitting one or more parameters that indicate a period of the downlink control channel for the UE, the one or more parameters including a first parameter and a second parameter, the first parameter indicating the second number of repetitions to be transmitted to the UE via the downlink control channel and the second parameter indicating a starting TTI of the one or more TTIs.

In some examples of the method, apparatuses, and non-transitory computer-readable medium described herein, the second number of repetitions may be an integer multiple of the first number of repetitions.

### BRIEF DESCRIPTION OF THE DRAWINGS

FIGS. 1 and 2 illustrate examples of wireless communications systems that support control channel adjustment for connected state in accordance with aspects of the present disclosure.

FIGS. 3A through 3D illustrate examples of mapping configurations that support control channel adjustment for connected state in accordance with aspects of the present disclosure.

FIGS. 4A through 4E illustrate examples of mapping configurations that support control channel adjustment for connected state in accordance with aspects of the present disclosure.

FIG. 5 illustrates an example of a process flow that supports control channel adjustment for connected state in accordance with aspects of the present disclosure.

FIGS. 6 and 7 show block diagrams of devices that support control channel adjustment for connected state in accordance with aspects of the present disclosure.

FIG. 8 shows a block diagram of a communications manager that supports control channel adjustment for connected state in accordance with aspects of the present disclosure.

FIG. 9 shows a diagram of a system including a device that supports control channel adjustment for connected state in accordance with aspects of the present disclosure.

FIGS. 10 and 11 show block diagrams of devices that support control channel adjustment for connected state in accordance with aspects of the present disclosure.

FIG. 12 shows a block diagram of a communications manager that supports control channel adjustment for connected state in accordance with aspects of the present disclosure.

FIG. 13 shows a diagram of a system including a device that supports control channel adjustment for connected state in accordance with aspects of the present disclosure.

FIGS. 14 through 19 show flowcharts illustrating methods that support control channel adjustment for connected state in accordance with aspects of the present disclosure.

### DETAILED DESCRIPTION

In some cases, wireless communications may be deficient based on a lack of flexibility associated with control channel configuration. For example, a threshold number of narrow band physical downlink control channel (NPDCCH) repetitions (e.g., Rmax) for a radio resource control (RRC) connection between a user equipment (UE) and a base station may be configured statically. In such examples, the base station may transmit control signaling to the UE indicating an Rmax value that may be configured for the UE based on an initial (or current) channel condition of the UE. Statically signaling the control signaling may be deficient in cases where channel conditions change during the connection. For example, if the UE moves from a first location relatively close to the base station to a second location relatively far from the base station, the channel conditions at the UE may become worse, but as the control signaling is configured statically, the UE may have to wait until the next RRC reconfiguration to update the Rmax value. As such, the UE may not be configured with a sufficient number of NPDCCH repetitions, in some cases, resulting in a radio link failure (RLF). Additionally or alternatively, in some cases, the base station may configure the UE with a control channel repetition number based on the UE having poor channel conditions at the time of configuration (e.g., the UE is configured with a relatively high number of repetitions), and the channel conditions for the UE may improve. In such cases, the UE may be able to decode the control channel successfully using a lower number of repetitions than originally configured, which results inefficient use of communication resources by the base station.

In some examples, the base station may dynamically adjust a UE specific Rmax (e.g., control channel repetitions). For example, the base station may transmit, to the UE, an NPDCCH configuration in a control message via RRC signaling, where the NPDCCH configuration may specify a UE specific Rmax value. The UE may receive the control message and may apply the UE specific Rmax value to monitoring the NPDCCH. In some examples, the UE may transmit a limit indication indicating to the base station that the NPDCCH may be becoming a limiting factor. As such, the base station may transmit a control channel with an updated or adjusted Rmax value such that the UE may receive more control channel repetitions, and in some cases, with a different periodicity as compared to the NPDCCH configuration from the control message.

Aspects of the disclosure are initially described in the context of wireless communications systems. Aspects of the disclosure are then described in the context of mapping configurations and a process flow. Aspects of the disclosure are further illustrated by and described with reference to apparatus diagrams, system diagrams, and flowcharts that relate to control channel adjustment for connected state.

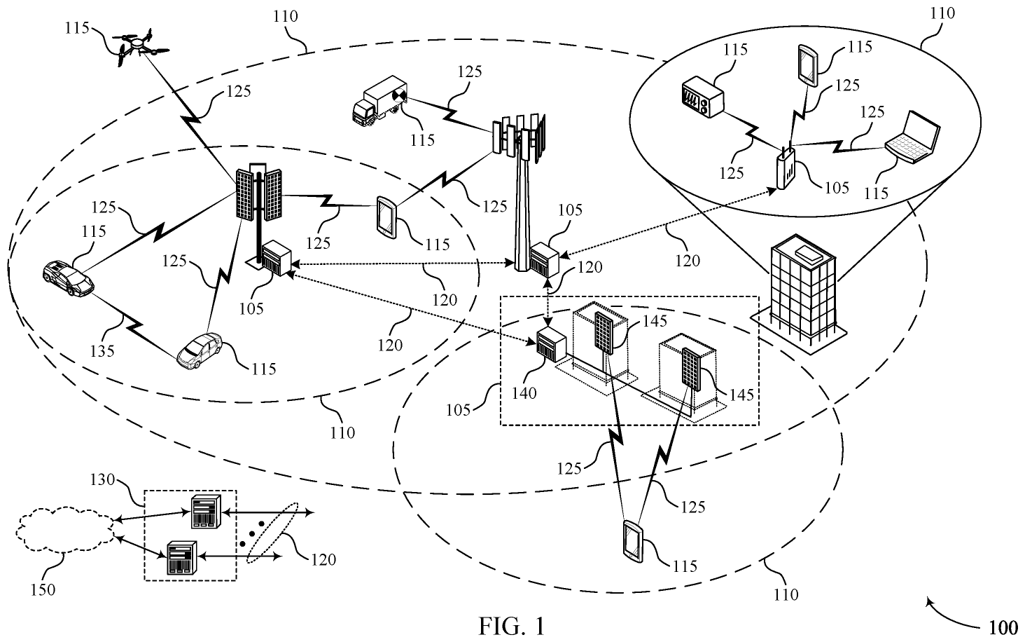

FIG. 1 illustrates an example of a wireless communications system 100 that supports control channel adjustment for connected state in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a ULE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, a network device such as a base station 105 may be implemented in a disaggregated architecture (e.g., a disaggregated base station architecture, a disaggregated RAN architecture), which may be configured to utilize a protocol stack that is physically or logically distributed among two or more devices, such as an IAB network, an open RAN (O-RAN) (e.g., a network configuration sponsored by the O-RAN Alliance), or a virtualized RAN (vRAN) (e.g., a cloud RAN (C-RAN)). For example, a base station 105 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof. An RU may also be referred to as a radio head, a smart radio head, a remote radio head (RRH), a remote radio unit (RRU), or a transmission reception point (TRP). One or more components of the base stations 105 in a disaggregated RAN architecture may be co-located, or one or more components of the base stations 105 may be located in distributed locations (e.g., separate physical locations). In some examples, one or more base stations 105 of a disaggregated RAN architecture may be implemented as virtual units (e.g., a virtual CU (VCU), a virtual DU (VDU), a virtual RU (VRU)).

The split of functionality between a CU, a DU, and an 170 is flexible and may support different functionalities depending on which functions (e.g., network layer functions, protocol layer functions, baseband functions, RF functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some examples, the CU may host upper protocol layer (e.g., layer 3 (L3), layer 2 (L2)) functionality and signaling (e.g., RRC, service data adaption protocol (SDAP), PDCP). The CU may be connected to one or more DUs 165 or RUs, and the one or more DUs or RUs may host lower protocol layers, such as layer 1 (L1) (e.g., physical (PHY) layer) or L2 (e.g., RLC layer, MAC layer) functionality and signaling, and may each be at least partially controlled by the CU. Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some cases, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU). A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some examples, a midhaul communication link or a fronthaul communication link may be implemented in accordance with an interface (e.g., a channel) between layers of a protocol stack supported by respective base stations 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more base stations 105 may be partially controlled by each other. One or more IAB nodes may be referred to as a donor entity or an IAB donor. One or more DUs or one or more RUs may be partially controlled by one or more CUs associated with a donor entity (e.g., a donor base station 105). The one or more donor base stations 105 (e.g., IAB donors) may be in communication with one or more additional base stations 105 via supported access and backhaul links. IAB nodes may include an IAB mobile termination (IAB-MT) controlled (e.g., scheduled) by DUs of a coupled IAB donor. An IAB-MT may include an independent set of antennas for relay of communications with UEs 115, or may share the same antennas (e.g., of an RU) of an IAB node used for access via the DU of the IAB node (e.g., referred to as virtual IAB-MT (vIAB-MT)). In some examples, the IAB nodes may include DUs that support communication links with additional entities (e.g., IAB nodes, UEs 115) within the relay chain or configuration of the access network (e.g., downstream). In such cases, one or more components of the disaggregated RAN architecture (e.g., one or more IAB nodes or components of IAB nodes) may be configured to operate according to the techniques described herein.

In the case of the techniques described herein applied in the context of a disaggregated RAN architecture, one or more components of the disaggregated RAN architecture may be configured to support systems and techniques for secure SRS communication as described herein. For example, some operations described as being performed by a UE 115 or a base station 105 may additionally, or alternatively, be performed by one or more components of the disaggregated RAN architecture (e.g., IAB nodes, DUs, CUs, RUs, RIC, SMO).

In some examples, the base station 105 may adjust a UE specific Rmax (e.g., control channel repetitions) with reduced overhead. For example, the base station 105 may transmit, to the UE 115, a control channel configuration, such as an NPDCCH configuration, in a control message via RRC signaling, where the NPDCCH configuration may specify a UE specific Rmax value. The UE 115 may receive the control message and may apply the UE specific Rmax value when monitoring for the NPDCCH. In some examples, the UE 115 may transmit an explicit indication that the UE 115 has reached a limit of NPDCCH decoding. In some examples, the UE 115 may transmit a limit indication indicating to the base station 105 that the NPDCCH may be becoming a limiting factor. As such, the base station 105 may transmit a control channel with an updated or adjusted Rmax value such that the UE 115 may receive more control channel repetitions, and in some cases, with a different periodicity as compared to the NPDCCH configuration from the control message.

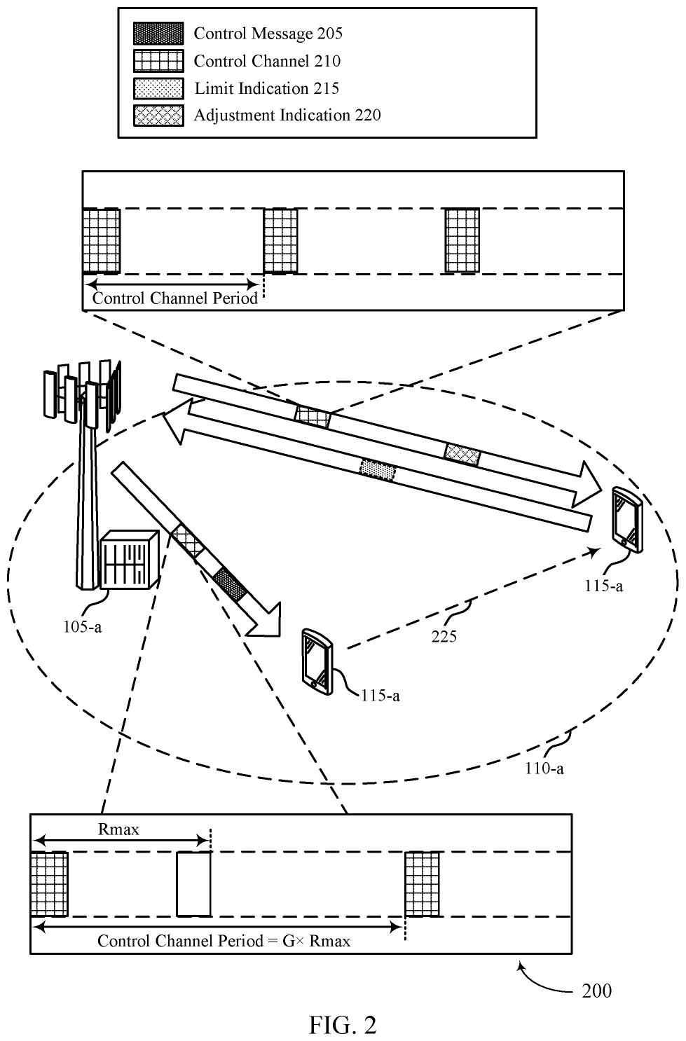

FIG. 2 illustrates an example of a wireless communications system 200 that supports control channel adjustment for connected state in accordance with aspects of the present disclosure. The wireless communications system 200 may implement or be implemented by aspects of the wireless communications system 100. For example, the wireless communications system 200 may include a UE 115-a and a base station 105-a, which may be examples of corresponding devices as described with reference to FIG. 1. The UE 115-a may communicate with the base station 105-a in a geographic coverage area 110-a, which may be an example of a geographic coverage area 110 described with reference to FIG. 1. The base station 105-a may transmit an adjustment indication 220 to the UE 115-a, while the UE 115-a is in a connected state, where the adjustment indication 220 may configure the UE 115-a to monitor a control channel 210 according to an adjusted number of control channel repetitions.

Some wireless communications systems may specify signaling for neighbor cell measurements and corresponding measurement triggering before RLF, for example, to reduce a time taken to establish an RRC connection to another cell without defining specific gaps (e.g., measurement gaps). That is, some wireless communications systems may support searching for neighboring cells to establish an RRC connection with, for example, in the event that channel conditions associated with a connection to a serving cell result in an RLF. In some cases, the purpose of such an objective may be to reduce a time elapsed for the UE 115-a to re-establish RRC connection after RLF. In some examples, mechanisms to fulfill this objective may include performing neighbor cell measurements in an RRC connected state so that the UE 115-a may have a candidate cell to select after an RLF. In such examples, the UE 115-a may reduce a time associated with finding a new serving cell. For example, the UE 115-a may start to acquire system information blocks (SIBs) (e.g., while in an RRC connected state) and then initiate an RRC connection establishment.

However, there may be issues associated with specifying signaling for neighbor cell measurements and corresponding measurement triggering before RLF. In some examples, an amount of time taken to search for a suitable cell (e.g., narrowband reference signal received power (NRSRP)) may vary depending on a number of frequencies on which the UE 115-a may search. For example, the more frequencies the UE 115-a may search to identify a suitable cell may result in more time taken to find the suitable cell. In some examples, a time taken to read neighbor cell SIBs and establish RRC connection with the neighbor cell may be unaffected. That is, there may be no latency gains associated with acquiring SIBs and establishing RRC connection. In some examples, several message exchanges may be associated with reestablishing an RRC connection. That is, specifying signaling for neighbor cell measurements and corresponding measurement triggering before RLF may fail to reduce overhead associated with RRC connection establishment message exchange. Further, in some cases, the UE 115-a may be configured to perform a registration update, resulting in NAS signaling, which may increase a delay to continue with data transfer and may increase UE 115-a power consumption. Irrespective of the registration update, there may be core network signaling associated with reestablishing an RRC connection with control plane (CP) optimization, for example, as the network may validate that the reestablishment may be initiated by the appropriate UE 115-a (e.g., for EPC). In such examples, the core network signaling may be used when the UE 115-a may be served by an AMF via an ng-eNB.

In some examples, RLF may occur due to one or more inefficiencies associated with monitoring the control channel 210. For example, the base station 105-a may transmit, and the UE 115-a may receive, a control message 205 including a configuration enabling the UE 115-a to monitor the control channel 210 in accordance with a control channel period. In some examples, the control channel 210 may be an NPDCCH and the NPDCCH period may be defined by a parameter Rmax (e.g., npdcch-NumRepetitions) and a parameter G (e.g., npdcch-StartSF-USS). In some cases, different NPDCCH periods corresponding to different Rmax and G values may be determined according to one or more stored values (e.g., in a table). As an illustrative example, NPDCCH periods may be determined using or otherwise referencing Table 1.

TABLE 1
NPDCCH Period

| | | Rmax (npdcch-NumRepetitions) | | | | | | | | | | | |
|---|---|---|---|---|---|---|---|---|---|---|---|---|---|
| | | 1 | 2 | 4 | 8 | 16 | 32 | 64 | 128 | 256 | 512 | 1024 | 2048 |
| G | 1.5 | 4 | 4 | 6 | 12 | 24 | 48 | 96 | 192 | 384 | 768 | 1536 | 3072 |
| (npdcch- | 2 | 4 | 4 | 8 | 16 | 32 | 64 | 128 | 256 | 512 | 1024 | 2048 | 4096 |
| StartSF- | 4 | 4 | 8 | 16 | 32 | 64 | 128 | 256 | 512 | 1024 | 2048 | 4096 | 8192 |
| USS) | 8 | 8 | 16 | 32 | 64 | 128 | 256 | 512 | 1024 | 2048 | 4096 | 8192 | 16384 |
| | 16 | 16 | 32 | 64 | 128 | 256 | 512 | 1024 | 2048 | 4096 | 8192 | 16384 | 32768 |
| | 32 | 32 | 64 | 128 | 256 | 512 | 1024 | 2048 | 4096 | 8192 | 16384 | 32768 | 65536 |
| | 48 | 48 | 96 | 192 | 384 | 768 | 1536 | 3072 | 6144 | 12288 | 24576 | 49152 | 98304 |
| | 64 | 64 | 128 | 256 | 512 | 1024 | 2048 | 4096 | 8192 | 16384 | 32768 | 65536 | 131072 |

Table 1 is shown with exemplary parameters and values, but may include additional or alternative parameters, values, and dimensions associated with determining an NPDCCH period. Further, the NPDCCH periods as shown in Table 1 may be represented in units of subframes, but may be alternatively represented in units of slots, symbols, or any other time frame associated with NPDCCH periods. In some examples, the UE 115-a may monitor a control channel in accordance with the parameters Rmax and G. For example, the UE 115-a may be configured to monitor Rmax subframes for every NPDCCH period. By way of example, with (Rmax, G)=(1, 2), the NPDCCH period may be 4 subframes (e.g., referencing Table 1) and the UE 115-a may monitor the first subframe (e.g., as Rmax is equal to 1). In another example, with (Rmax, G)=(16, 2), the NPDCCH period may be 32 subframes (e.g., referencing Table 1) and the UE 115-a may monitor the first 16 subframes (e.g., as Rmax is equal to 16). In some cases, Rmax may be a threshold number of NPDCCH repetitions, such that the UE 115-a may monitor the NPDCCH for a subset of the Rmax subframes. For example, with (Rmax, G)=(16, 2), the UE 115-a may monitor the NPDCCH for the first 16 subframes of the NPDCCH or less.

In some cases, such as in NB-IoT implementations with CP optimization, devices may lack AS security and RRC reconfiguration may be absent. In such cases, the dedicated resource for physical downlink shared channel (PDSCH), and physical uplink shared channel (PUSCH) may be allocated by the NPDCCH. Depending on the radio condition, the NPDCCH may indicate a threshold number of repetitions that may be used for PUSCH or PDSCH. In such cases, as the UE 115-a moves between different coverage levels within the cell, the base station 105-a may adapt, via NPDCCH, the dedicated resource allocation for PDSCH or PUSCH. However, such wireless communications may be deficient based on the lack of flexibility associated with the NPDCCH configuration. For example, a threshold number of NPDCCH repetitions (e.g., Rmax) for the RRC connection may be configured by control signaling 305. That is, the base station 105-a may transmit control signaling 305 to the UE 115-a indicating an Rmax value that may be appropriate for an initial (or current) channel condition. In such examples, the base station 105-a may transmit the control signaling 305 statically, for example, using RRC signaling. Statically signaling the control signaling 305 may be deficient in cases where channel conditions change during the connection.

For example, if the UE 115-a moves along path 225 from a first location relatively close to the base station 105-a to a second location relatively far from the base station 105-a, the channel conditions at the UE 115-a may become worse, but as the control signaling 305 is configured statically, the UE 115-a may have to wait until the next RRC reconfiguration to update the Rmax value. As such, the UE 115-a may not be configured with a sufficient number of NPDCCH repetitions, in some cases, resulting in an RLF. Further, in NB-IoT implementations, the threshold number of NPDCCH repetitions may be unable to be changed as RRC connection reconfiguration may not be permitted in NB-IoT when AS security is not configured. Additionally or alternatively, in some cases, the base station 105-a may configure the UE 115-a with a control channel repetition number based on the UE 115-a having poor channel conditions at the time of configuration (e.g., the UE 115-a is configured with a high number of repetitions), and the channel conditions for the UE 115-a may improve. In such cases, the UE 115-a may be able to decode the control channel successfully using a lower number of repetitions than originally configured, which results inefficient use of communication resources by the base station 105-a. For example, the UE 115-a may be able to decode the control channel using 4 repetitions, but the base station 105-a may have previously configured the control channel with 256 repetitions, which are no longer necessary for successful decoding at the UE 115-a and the base station 105-a may end up wasting NPDCCH resources. As with NPDCCH, the number of repetitions to use for narrow band PUCCH (NPUCCH) may also be configured by RRC signaling (e.g., ack-Nack-NumRepetitions-NB).

In some examples, the base station 105-a may adjust a UE specific Rmax with minimal signaling. For example, the base station 105-a may transmit, to the UE 115-a, an NPDCCH configuration in a control message 205 via RRC signaling (e.g., RRCConnectionSetup), where the NPDCCH configuration may specify a UE specific Rmax value. The UE 115-a may receive the control message 205 and may apply the UE specific Rmax value to monitoring the NPDCCH (e.g., and in accordance with a respective control channel period). In some examples, the UE 115-a may receive the control channel 210 and may combine a reception of one or more NPDCCH subframes to improve a probability of successful reception of NPDCCH. For example, if the UE specific Rmax=4, the UE 115-a may attempt to decode the control channel 210 either from monitoring one subframe, by combining two subframes, or by combining all four subframes. In some cases, the UE 115-a may use different NPDCCH subframe combinations equal to Rmax/n, where n=1, 2, 4, or 8 and Rmax/n>=1. In some examples, the base station 105-a may detect that the coverage level between the UE 115-a and the base station 105-a is getting poor (e.g., the base station 105-a may configure a higher number of repetitions for PDSCH or PUSCH to successfully exchange data). In such examples, the base station 105-a may transmit the adjustment indication 220 to indicate the UE 115-a to use a higher Rmax value than the Rmax value configured in the control message 205. For example, if the Rmax configured in the control message 205 was Rmax=8, then the UE 115-a may switch to using the next Rmax value, Rmax=16. In some examples, the same indication may also be used to increase the number of repetitions to use for NPUCCH, for example, to multiply an NPUCCH value configured by RRC signaling by a factor of two. Each time the Rmax value is doubled may correspond to a 3 decibel (dB) gain compared to an initial or currently used value.

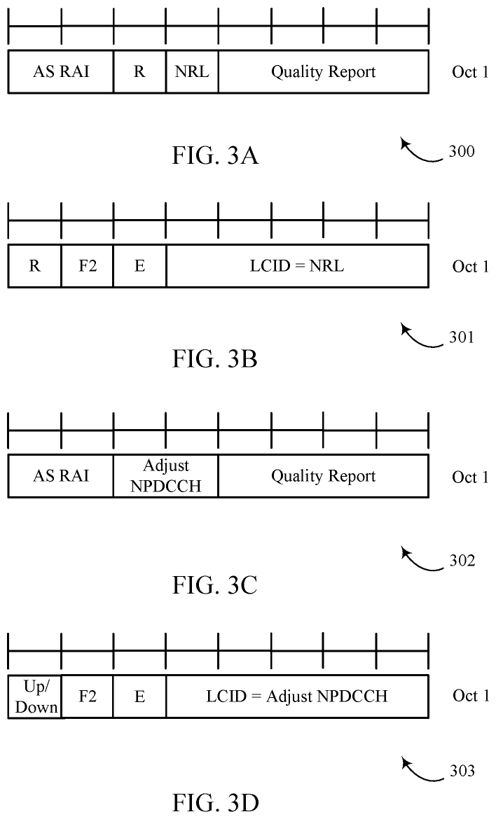

In some examples, the UE 115-a may transmit an explicit indication that the UE 115-a has reached a limit of NPDCCH decoding. For example, the UE 115-a may detect that NPDCCH reception is getting poor, for example, the UE 115-a may use Rmax repetitions (instead of a subset of Rmax) to successfully decode the NPDCCH. In wireless communications system 200, the UE 115-a may move along path 225 from a location relatively proximal to the base station 105-a to a location relatively far away from the base station 105-a (e.g., near the edge of coverage area 110-a). In some examples, the movement of UE 115-a may be associated with a change in communications channel conditions. In this example, the communications channel may depreciate as the UE 115-a moves along path 225. In such examples, the UE 115-a may transmit a limit indication 215 indicating to the base station 105-a that the NPDCCH may be becoming a limiting factor. As such, the base station 105-a may transmit a control channel 210 with an updated or adjusted Rmax value such that the UE 115-a may receive more control channel repetitions, and in some cases, with a different periodicity as compared to the NPDCCH configuration from the control message 205. Additionally or alternatively, the base station 105-a may configure a threshold for NPDCCH channel quality (e.g., via broadcast or unicast signaling) and in cases where the channel quality falls below the threshold, the UE 115-a may send the limit indication 215 that the NPDCCH limit has been reached. In some examples, the UE 115-a may transmit the limit indication 215 as or within a channel quality information (CQI) MAC-CE in an uplink PUSCH transmission, in some cases, including a new indicator (e.g., an NPDCCH reaching limit (NRL) indicator as described in more detail with reference to FIGS. 3A and 3B). The base station 105-a may use the limit indication 215 to trigger the UE 115-a to use a next Rmax value.

Configuring devices to reconfigure a number of control channel repetitions dynamically may enable more channel decoding flexibility, resulting in less frequent RLF and mitigating corresponding RRC reestablishment, which in turn reduces resource usage and maintains higher throughput.

FIG. 3A illustrates an example of a mapping configuration 300 that supports control channel adjustment for connected state in accordance with aspects of the present disclosure. In some examples, the mapping configuration 300 may implement aspects of wireless communications systems 100 or 200. In this example, a UE may transmit a limit indication such as limit indication 215 as described with reference to FIG. 2 as or within a MAC CE in accordance with mapping configuration 300.

In some examples, the UE may indicate to a network that an NPDCCH is becoming a limiting factor to maintain the connection between the UE and the network by sending a MAC CE in accordance with mapping configuration 300. For example, the UE may detect that a communications channel between the UE and a base station is getting poor, for example, based on monitoring an NPDCCH at a threshold number of control channel repetitions, a channel quality threshold being satisfied, among other channel quality metrics indicating that the communications channel is getting poor. As such, the UE may include the indication in a MAC CE used for reporting downlink channel quality. In such cases, a previous reserved bit may be changed to an NRL bit. In some examples, a UE that supports NPDCCH Rmax adjustment may use the previous reserved bit for NRL. In such examples, an NRL bit with value 1 may indicate that the NPDCCH may be a limiting factor and an NRL bit with value 0 may imply no indication. The MAC CE octet in mapping configuration 300 (e.g., eight information bits) may, thus, include an access stratum (AS) release assistance indication (RAI) field, a reserved field (e.g., R), an NRL field, and a quality report. In mapping configuration 300, the UE may include the AS RAI with two bits, the reserved field with one bit, the NRL with one bit, and the quality report with four bits. In some examples, the UE may transmit the limit indication in accordance with mapping configuration 300 in cases where the UE has downlink CQI to send in addition to NRL. The base station may receive the limit indication and may update the UE with a new Rmax value, for example, with an adjustment indication 220 as described with reference to FIG. 2.

FIG. 3B illustrates an example of a mapping configuration 301 that supports control channel adjustment for connected state in accordance with aspects of the present disclosure. In some examples, the mapping configuration 301 may implement aspects of wireless communications systems 100 or 200. In this example, a UE may transmit a limit indication such as limit indication 215 as described with reference to FIG. 2 as or within a MAC CE in accordance with mapping configuration 301.

In some examples, the UE may indicate to a network that an NPDCCH is becoming a limiting factor to maintain the connection between the UE and the network by sending a MAC CE in accordance with mapping configuration 301. For example, the UE may detect that a communications channel between the UE and a base station is getting poor, for example, based on monitoring an NPDCCH at a threshold number of control channel repetitions, a channel quality threshold being satisfied, among other channel quality metrics indicating that the communications channel is getting poor. As such, the UE may include the indication in a new MAC CE that signals NRL. Such a MAC CE may have no additional payload. The MAC CE octet in mapping configuration 301 (e.g., eight information bits) may, thus, include a reserved field (e.g., R), an F2 field, and E field, and a logical channel identifier (LCID) field including an NRL. In mapping configuration 300, the UE may include the reserved field with one bit, the F2 field with one bit, the E field with one bit, and the LCID field with five bits. Reserved (e.g., spare) LCID values or other uplink LCID values not applicable to NB-IoT may be used for NRL (e.g., values in the range 01110 through 01111). In some examples, the UE may transmit the limit indication in accordance with mapping configuration 301 in cases where the UE has NRL to send. The base station may receive the limit indication and may update the UE with a new Rmax value, for example, with an adjustment indication 220 as described with reference to FIG. 2.

FIG. 3C illustrates an example of a mapping configuration 302 that supports control channel adjustment for connected state in accordance with aspects of the present disclosure. In some examples, the mapping configuration 300 may implement aspects of wireless communications systems 100 or 200. In this example, a UE may transmit a limit indication such as limit indication 215 as described with reference to FIG. 2 as or within a MAC CE in accordance with mapping configuration 302.

In some examples, the UE may indicate to a network that an NPDCCH is becoming a limiting factor to maintain the connection between the UE and the network or that the NPDCCH is over configured by sending a MAC CE in accordance with mapping configuration 302. For example, the UE may detect that a communications channel between the UE and a base station is getting poor, for example, based on monitoring an NPDCCH at a threshold number of control channel repetitions, a channel quality threshold being satisfied, among other channel quality metrics indicating that the communications channel is getting poor. As such, the UE may include the indication in a MAC CE used for reporting downlink channel quality. In such cases, previous reserved bits may be changed to adjust NPDCCH bits. In some examples, a UE that supports NPDCCH adjustment may use the previous reserved bits to signal adjust NPDCCH. In such examples, an adjust NPDCCH field with value 01 may indicate that the UE may adjust to higher NPDCCH repetitions, an adjust NPDCCH field with value 10 may indicate that the UE may adjust to lower NPDCCH repetitions, and an adjust NPDCCH field with value 00 may imply no indication to adjust NPDCCH. The MAC CE octet in mapping configuration 302 (e.g., eight information bits) may, thus, include an AS RAI field, an adjust NPDCCH field, and a quality report. In mapping configuration 300, the UE may include the AS RAI field with two bits, adjust NPDCCH field with two bits, and the quality report with four bits. In some examples, the UE may transmit the limit indication in accordance with mapping configuration 302 in cases where the UE has downlink CQI to send in addition to NRL. The base station may receive the limit indication and may update the UE with a new Rmax value, for example, with an adjustment indication 220 as described with reference to FIG. 2.

FIG. 3D illustrates an example of a mapping configuration 303 that supports control channel adjustment for connected state in accordance with aspects of the present disclosure. In some examples, the mapping configuration 303 may implement aspects of wireless communications systems 100 or 200. In this example, a UE may transmit a limit indication such as limit indication 215 as described with reference to FIG. 2 as or within a MAC CE in accordance with mapping configuration 303.

In some examples, the UE may indicate to a network that an NPDCCH is becoming a limiting factor to maintain the connection between the UE and the network or that the NPDCCH is over configured by sending a MAC CE in accordance with mapping configuration 303. For example, the UE may detect that a communications channel between the UE and a base station is getting poor, for example, based on monitoring an NPDCCH at a threshold number of control channel repetitions, a channel quality threshold being satisfied, among other channel quality metrics indicating that the communications channel is getting poor. As such, the UE may include the indication in a new MAC CE that signals an adjust NPDCCH. Such a MAC CE may have no additional payload. The MAC CE octet in mapping configuration 303 (e.g., eight information bits) may, thus, include an Up/Down field, an F2 field, and E field, and an LCID field including an adjust PDCCH indication. In some examples, the Up/Down field may indicate whether to increase NPDCCH repetitions or to decrease repetitions. In mapping configuration 300, the UE may include the Up/Down with one bit, the F2 field with one bit, the E field with one bit, and the LCID field with five bits. Reserved (e.g., spare) LCID values or other uplink LCID values not applicable to NB-IoT may be used for NRL (e.g., values in the range 01110 through 01111). In some examples, the UE may transmit the limit indication in accordance with mapping configuration 303 in cases where the UE has an adjust NPDCCH to send. The base station may receive the limit indication and may update the UE with a new Rmax value, for example, with an adjustment indication 220 as described with reference to FIG. 2.

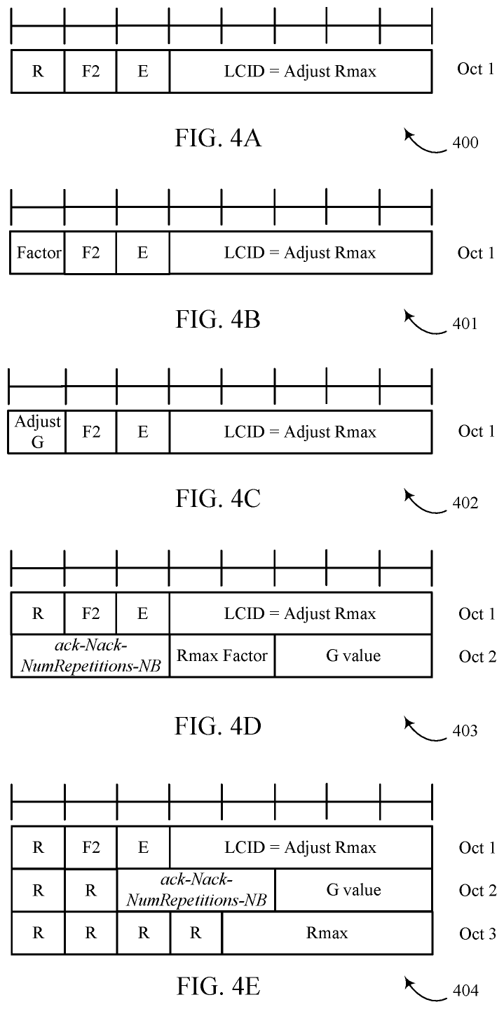

FIG. 4A illustrates an example of a mapping configuration 400 that supports control channel adjustment for connected state in accordance with aspects of the present disclosure. In some examples, the mapping configuration 400 may implement aspects of wireless communications systems 100 or 200. In this example, a base station may transmit an adjustment indication such as adjustment indication 220 as described with reference to FIG. 2 as or within a MAC CE in accordance with mapping configuration 400.

In some examples, a network (e.g., the base station) may signal to a UE to adjust Rmax to a next possible value (e.g., if configured Rmax was 8, then double to 16). For example, the network may use a new MAC CE to command the UE to double the Rmax. In such cases, an unused downlink LCID may be used for such a command (e.g., values in the range 01110 through 01111, or another downlink LCID value not applicable to NB-IoT). The MAC CE octet in mapping configuration 400 (e.g., eight information bits) may, thus, include a reserved field (e.g., R), an F2 field, and E field, and an LCID field including an adjust Rmax field. In mapping configuration 400, the UE may include the reserved field with one bit, the F2 field with one bit, the E field with one bit, and the LCID field with five bits. Additionally, the base station may transmit an SIB including a multiplication factor (e.g., being an integer greater than one), where the MAC CE (e.g., the LCID field) may indicate to the UE to apply the multiplication factor to an RRC configured Rmax value, such as an Rmax value as configured in control message 205 as described with reference to FIG. 2. In some cases, the multiplication factor may be known to wireless devices (e.g., loaded to the wireless devices). In some examples, the UE may apply the same multiplication factor to a PUCCH (e.g., to adjust ack-Nack-NumRepetitions-NB by the same factor as applied to Rmax).

FIG. 4B illustrates an example of a mapping configuration 401 that supports control channel adjustment for connected state in accordance with aspects of the present disclosure. In some examples, the mapping configuration 401 may implement aspects of wireless communications systems 100 or 200. In this example, a base station may transmit an adjustment indication such as adjustment indication 220 as described with reference to FIG. 2 as or within a MAC CE in accordance with mapping configuration 401.

In some examples, a network (e.g., the base station) may signal to a UE to adjust Rmax to an adjusted value. In such cases, an unused downlink LCID may be used for such a command (e.g., values in the range 01110 through 01111, or another downlink LCID value not applicable to NB-IoT). Additionally, a reserved field may be replaced by a factor field, the factor field indicating an adjustment factor. For example, if the factor field has a value of 0, then the UE may double Rmax and if the factor field has a value of 1, then the UE may quadruple Rmax. The MAC CE octet in mapping configuration 401 (e.g., eight information bits) may, include a factor field, an F2 field, and E field, and an LCID field including an adjust Rmax field. In mapping configuration 401, the UE may include the factor field with one bit, the F2 field with one bit, the E field with one bit, and the LCID field with five bits. Additionally, the base station may transmit an SIB including two multiplication factors (e.g., each multiplication factor being an integer greater than one), where the MAC CE (e.g., the LCID field) may indicate to the UE to apply the multiplication factor to an RRC configured Rmax value, such as an Rmax value as configured in control message 205 as described with reference to FIG. 2. In examples, where the base station transmits the SIB including two multiplication factors, the factor bit in the MAC CE may indicate which of the two multiplication factors in the SIB to apply (e.g., factor bit=0 means apply a first multiplication factor and factor bit=1 means apply a second multiplication factor). In some cases, the multiplication factor may be known to wireless devices (e.g., loaded to the wireless devices). In some examples, the UE may apply the same multiplication factor to a PUCCH (e.g., to adjust ack-Nack-NumRepetitions-NB by the same factor as applied to Rmax).

FIG. 4C illustrates an example of a mapping configuration 402 that supports control channel adjustment for connected state in accordance with aspects of the present disclosure. In some examples, the mapping configuration 402 may implement aspects of wireless communications systems 100 or 200. In this example, a base station may transmit an adjustment indication such as adjustment indication 220 as described with reference to FIG. 2 as or within a MAC CE in accordance with mapping configuration 402.

In some examples, an NPDCCH period may depend on the parameters Rmax and G. In cases where Rmax is doubled, then the NPDCCH period, in most cases, is also doubled. In some cases, an NPDCCH period can be maintained, or otherwise kept the same by reducing G. For example, if configured (Rmax, G)=(16,8) then the NPDCCH period may be kept the same if G is adjusted from 8 to 4 and Rmax is increased from 16 to 32. Therefore, the adjusted (Rmax, G)=(32, 4). Similarly, a configured (Rmax, G)=(64, 64) can be adjusted to (128, 32). As such, a network (e.g., the base station) may signal to a UE to increase Rmax and reduce G to improve NPDCCH reception performance, but maintain NPDCCH period. The MAC CE octet in mapping configuration 402 (e.g., eight information bits) may, include an adjust G field, an F2 field, and E field, and an LCID field including an adjust Rmax field. In mapping configuration 402, the UE may include the adjust G field with one bit, the F2 field with one bit, the E field with one bit, and the LCID field with five bits. Adjusting Rmax may imply an increase of Rmax at the UE by a factor of two and adjusting G may imply a decrease in G by a factor of 2 to maintain an NPDCCH period. However, some G values are not powers of 2 with respect to other G values (e.g., 1.5 and 48 as compared to 2, 4, 8, 16, 32, and 64). In such examples, devices may fail to maintain the NPDCCH period.

FIG. 4D illustrates an example of a mapping configuration 403 that supports control channel adjustment for connected state in accordance with aspects of the present disclosure. In some examples, the mapping configuration 403 may implement aspects of wireless communications systems 100 or 200. In this example, a base station may transmit an adjustment indication such as adjustment indication 220 as described with reference to FIG. 2 as or within a MAC CE in accordance with mapping configuration 403.

In some examples, a network (e.g., the base station) may signal to a UE an explicit configuration for one or more control channels. In the case of mapping configuration 403, the base station may signal a 2-octet MAC CE, with one octet (e.g., Oct 2) to carry an explicit value for G (e.g., one of 1.5, 2, 4, 8, 16, 32, 48, 64), Rmax factor (e.g., 1.5, 2, 4, 8), and an explicit value for ack-Nack-NumRepetitions-NB (e.g., 1, 2, 4, 8, 16, 32, 64). In such cases, an unused downlink LCID may be used for such a command an NPDCCH and PUCCH adjust indication, indicating whether the NPDCCH, the PUCCH, or both should be adjusted with the explicit values in Oct 2.

FIG. 4E illustrates an example of a mapping configuration 404 that supports control channel adjustment for connected state in accordance with aspects of the present disclosure. In some examples, the mapping configuration 404 may implement aspects of wireless communications systems 100 or 200. In this example, a base station may transmit an adjustment indication such as adjustment indication 220 as described with reference to FIG. 2 as or within a MAC CE in accordance with mapping configuration 404.

In some examples, a network (e.g., the base station) may signal to a UE an explicit configuration for one or more control channels. In the case of mapping configuration 403, the base station may signal a 3-octet MAC CE, with one octet (e.g., Oct 3) to carry an explicit value for an Rmax factor (e.g., 1.5, 2, 4, 8), another octet (e.g., Oct 2) to carry explicit values for G (e.g., one of 1.5, 2, 4, 8, 16, 32, 48, 64), and an explicit value for ack-Nack-NumRepetitions-NB (e.g., 1, 2, 4, 8, 16, 32, 64). In such cases, an unused downlink LCID may be used for such a command an NPDCCH and PUCCH adjust indication, indicating whether the NPDCCH, the PUCCH, or both should be adjusted with the explicit values in Oct 2 and Oct 3.

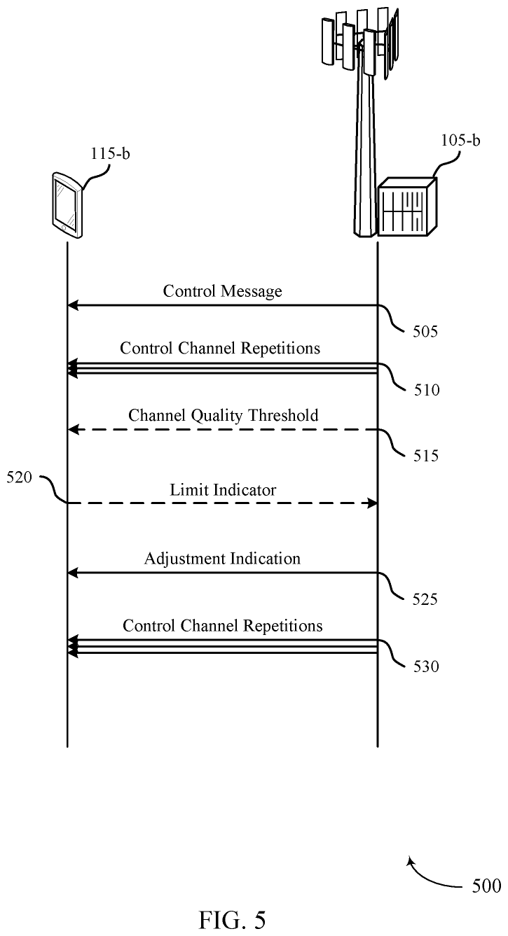

FIG. 5 illustrates an example of a process flow 500 that supports control channel adjustment for connected state in accordance with aspects of the present disclosure. In some examples, the process flow 500 may implement aspects of wireless communications systems 100 or 200. For example, process flow 500 may include UE 115-b and base station 105-b, which may be examples of corresponding devices as described with reference to FIGS. 1 and 2. In some cases, UE 115-b may be in a connected state with the base station 105-b. In some examples, the base station 105-b may dynamically update the UE 115-b with a number of control channel repetitions, enhancing control channel monitoring flexibility at the UE 115-b.

In the following description of the process flow 500, the operations may be performed (e.g., reported or provided) in a different order than the order shown, or the operations performed by the UE 115-b and the base station 105-b may be performed in different orders or at different times. For example, specific operations also may be left out of the process flow 500, or other operations may be added to the process flow 500. Further, although some operations or signaling may be shown to occur at different times for discussion purposes, these operations may actually occur at the same time.

At 505, the UE 115-b may receive a control message from the base station 105-b, the control message indicating a number of repetitions to be transmitted to the UE 115-b via a downlink control channel (e.g., NPDCCH). In some examples, the UE 115-b may receive the control message via RRC signaling and the downlink control channel may include a PDCCH. In some examples, the UE 115-b may receive one or more parameters that indicate a period of the downlink control channel for the UE 115-b, the one or more parameters including a first parameter and a second parameter, the first parameter indicating the second number of repetitions to be transmitted to the UE 115-b via the downlink control channel and the second parameter indicating a starting TTI of the one or more TTIs.

At 510, the base station 105-b may transmit, and the UE 115-b may monitor for and receive a downlink control channel according to a first number of repetitions. In such examples, the first number of repetitions may be the number of repetitions as indicated in the control message at 505.

In some cases, at 520, the UE 115-b may transmit a limit indicator for the downlink control channel that a control channel limit associated with the downlink control channel has been reached, where the indication to adjust the number of repetitions is in response to the limit indicator. In some cases, the UE 115-b may transmit the limit indicator based on a channel quality threshold. For example, at 515, the UE 115-b may receive, from the base station 105-b, a channel quality threshold associated with the downlink control channel, where the limit indicator may be transmitted based on a channel quality associated with the downlink control channel crossing the channel quality threshold. In some cases, the channel quality threshold may be associated with a channel quality measurement, the UE 115-b monitoring the downlink control channel in accordance with the first number of repetitions, among other factors associated with the channel quality threshold. In some examples, the UE 115-b may transmit the limit indicator in a control element of an uplink message (e.g., a MAC CE in accordance with a mapping configuration described with reference to FIGS. 3A through 3D), where the control element may be configured for limit indicator reporting or the uplink message may be associated with downlink channel quality reporting. Additionally, in some cases, the limit indicator may be a request to adjust the number of repetitions to be transmitted to the UE 115-b via the downlink control channel.

At 525, the UE 115-b may receive, in a connected state, an indication to adjust the number of repetitions to be transmitted to the UE 115-b via the downlink control channel from a first number of repetitions to a second number of repetitions. Phrased alternatively, the UE 115-b may receive an adjustment indication such that the UE 115-b may monitor the downlink control channel according to the second number of repetitions, in some cases, to compensate for the channel quality threshold being satisfied. In some cases, the second number of repetitions is an integer multiple of the first number of repetitions. In some examples, the UE 115-b may receive the adjustment indication to adjust the number of repetitions by a step factor (e.g., a next Rmax value as described with reference to FIG. 2). In some examples, the UE 115-b may receive the adjustment indication to adjust the number of repetitions by a multiplication factor of the first number of repetitions. In some cases, the multiplication factor may be from a set of defined multiplication factors (e.g., loaded to devices). In some cases, the multiplication factor may be from a set of multiplication factors received via broadcast signaling (e.g., from the base station 105-b). In some examples, receiving the adjustment indication further includes, receiving an indication to increase or decrease the number of repetitions, where the increase or decrease of the number of repetitions maintains a periodicity associated with the downlink control channel that corresponds to the first number of repetitions. Additionally or alternatively, receiving the adjustment indication may include receiving an indication to adjust a number of repetitions to be transmitted by the UE 115-b via an uplink control channel (e.g., PUCCH).

At 530, the base station 105-b may transmit, and the UE 115-b may monitor for and receive a downlink control channel according to a second, adjusted, number of repetitions. In such examples, the second number of repetitions may be the number of repetitions based on a multiplication factor or an increase or decrease relative to the first number of repetitions transmitted at 510.

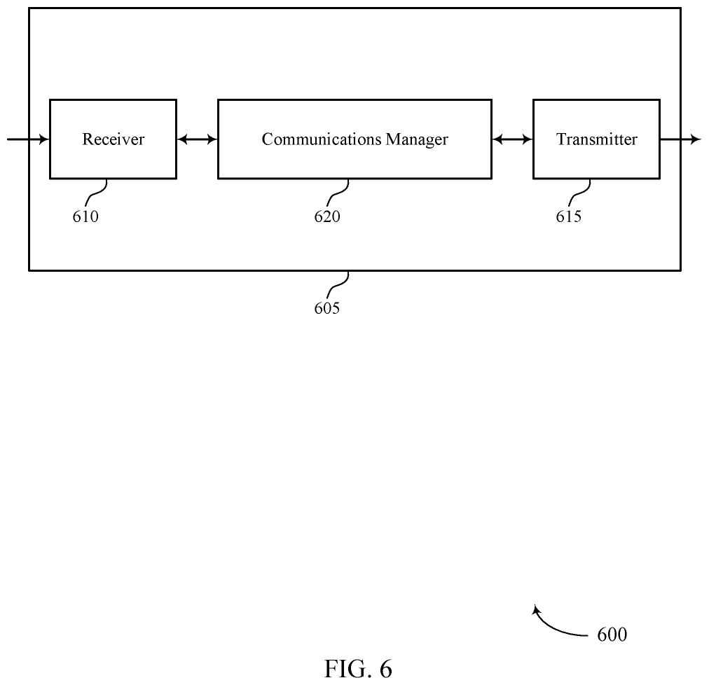

FIG. 6 shows a block diagram 600 of a device 605 that supports control channel adjustment for connected state in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to control channel adjustment for connected state). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to control channel adjustment for connected state). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of control channel adjustment for connected state as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. For example, the communications manager 620 may be configured as or otherwise support a means for receiving a control message from a base station, the control message indicating a number of repetitions to be transmitted to the UE via a downlink control channel. The communications manager 620 may be configured as or otherwise support a means for receiving, at the UE in a connected state, an indication to adjust the number of repetitions to be transmitted to the UE via the downlink control channel from a first number of repetitions to a second number of repetitions. The communications manager 620 may be configured as or otherwise support a means for monitoring, by the UE in the connected state, one or more TTIs for the downlink control channel based on the second number of repetitions, where a number of the one or more TTIs corresponds to the second number of repetitions.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for dynamically updating a number of repetitions for a control channel, resulting in reduced processing, reduced power consumption, and more efficient utilization of communication resources. Such techniques may also increase the likelihood of decoding success at the device 605, which may lead to improved user experience and reduced latency.

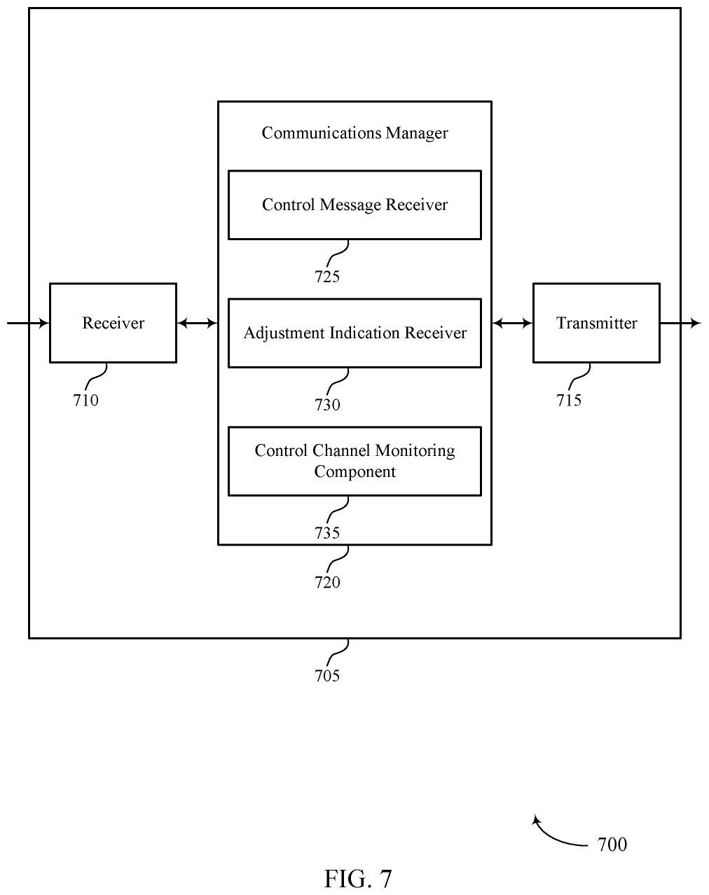

FIG. 7 shows a block diagram 700 of a device 705 that supports control channel adjustment for connected state in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to control channel adjustment for connected state). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to control channel adjustment for connected state). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of control channel adjustment for connected state as described herein. For example, the communications manager 720 may include a control message receiver 725, an adjustment indication receiver 730, a control channel monitoring component 735, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communications at a UE in accordance with examples as disclosed herein. The control message receiver 725 may be configured as or otherwise support a means for receiving a control message from a base station, the control message indicating a number of repetitions to be transmitted to the UE via a downlink control channel. The adjustment indication receiver 730 may be configured as or otherwise support a means for receiving, at the UE in a connected state, an indication to adjust the number of repetitions to be transmitted to the UE via the downlink control channel from a first number of repetitions to a second number of repetitions. The control channel monitoring component 735 may be configured as or otherwise support a means for monitoring, by the UE in the connected state, one or more TTIs for the downlink control channel based on the second number of repetitions, where a number of the one or more TTIs corresponds to the second number of repetitions.

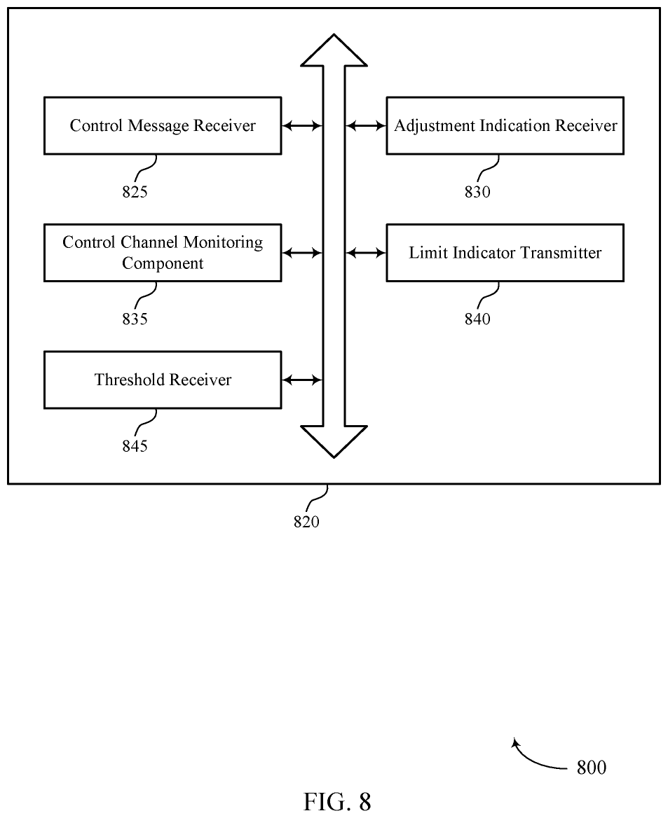

FIG. 8 shows a block diagram 800 of a communications manager 820 that supports control channel adjustment for connected state in accordance with aspects of the present disclosure. The communications manager 820 may be an example of aspects of a communications manager 620, a communications manager 720, or both, as described herein. The communications manager 820, or various components thereof, may be an example of means for performing various aspects of control channel adjustment for connected state as described herein. For example, the communications manager 820 may include a control message receiver 825, an adjustment indication receiver 830, a control channel monitoring component 835, a limit indicator transmitter 840, a threshold receiver 845, or any combination thereof. Each of these components may communicate, directly or indirectly, with one another (e.g., via one or more buses).

The communications manager 820 may support wireless communications at a UE in accordance with examples as disclosed herein. The control message receiver 825 may be configured as or otherwise support a means for receiving a control message from a base station, the control message indicating a number of repetitions to be transmitted to the UE via a downlink control channel. The adjustment indication receiver 830 may be configured as or otherwise support a means for receiving, at the UE in a connected state, an indication to adjust the number of repetitions to be transmitted to the UE via the downlink control channel from a first number of repetitions to a second number of repetitions. The control channel monitoring component 835 may be configured as or otherwise support a means for monitoring, by the UE in the connected state, one or more TTIs for the downlink control channel based on the second number of repetitions, where a number of the one or more TTIs corresponds to the second number of repetitions.

In some examples, the limit indicator transmitter 840 may be configured as or otherwise support a means for transmitting a limit indicator for the downlink control channel indicating that a control channel limit associated with the downlink control channel has been reached, where the indication to adjust the number of repetitions is in response to the limit indicator.

In some examples, the threshold receiver 845 may be configured as or otherwise support a means for receiving, from the base station, a channel quality threshold associated with the downlink control channel, where the limit indicator is transmitted based on a channel quality associated with the downlink control channel crossing the channel quality threshold.

In some examples, to support transmitting the limit indicator, the limit indicator transmitter 840 may be configured as or otherwise support a means for transmitting the limit indicator in a control element of an uplink message, where the control element is configured for limit indicator reporting.

In some examples, to support transmitting the limit indicator, the limit indicator transmitter 840 may be configured as or otherwise support a means for transmitting the limit indicator in a control element of an uplink message, where the uplink message includes a downlink channel quality report.

In some examples, the limit indicator is a request to adjust the number of repetitions to be transmitted to the UE via the downlink control channel. In some examples, to support receiving the indication, the adjustment indication receiver 830 may be configured as or otherwise support a means for receiving the indication to adjust the number of repetitions by a step factor.

In some examples, to support receiving the indication, the adjustment indication receiver 830 may be configured as or otherwise support a means for receiving an indication to adjust the number of repetitions by a multiplication factor of the first number of repetitions. In some examples, the multiplication factor is from a set of defined multiplication factors. In some examples, the multiplication factor is from a set of multiplication factors received via broadcast signaling.

In some examples, to support receiving the indication, the adjustment indication receiver 830 may be configured as or otherwise support a means for receiving an indication to increase or decrease the number of repetitions, where the increase or decrease of the number of repetitions maintains a periodicity associated with the downlink control channel that corresponds to the first number of repetitions.

In some examples, to support receiving the indication, the adjustment indication receiver 830 may be configured as or otherwise support a means for receiving an indication to adjust a number of repetitions to be transmitted by the UE via an uplink control channel.

In some examples, to support receiving the control message, the control message receiver 825 may be configured as or otherwise support a means for receiving one or more parameters that indicate a period of the downlink control channel for the UE, the one or more parameters including a first parameter and a second parameter, the first parameter indicating the second number of repetitions to be transmitted to the UE via the downlink control channel and the second parameter indicating a starting TTI of the one or more TTIs.

In some examples, the second number of repetitions is an integer multiple of the first number of repetitions. In some examples, the control message is received via RRC signaling. In some examples, the downlink control channel includes a PDCCH.

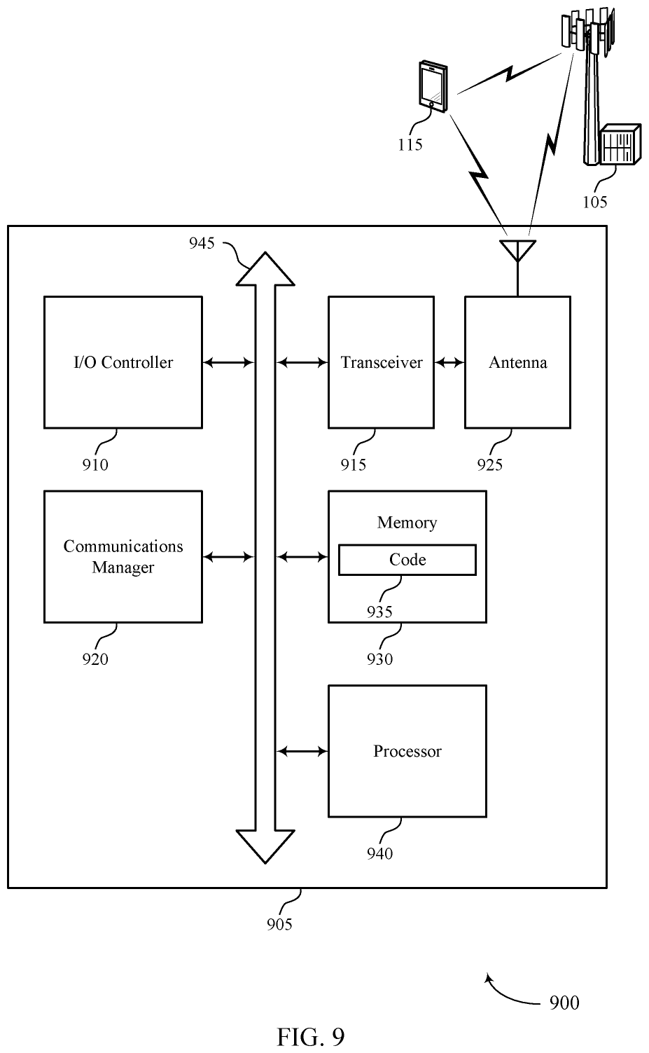

FIG. 9 shows a diagram of a system 900 including a device 905 that supports control channel adjustment for connected state in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting control channel adjustment for connected state). For example, the device 905 or a component of the device 905 may include a processor 940 and memory 930 coupled to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for receiving a control message from a base station, the control message indicating a number of repetitions to be transmitted to the UE via a downlink control channel. The communications manager 920 may be configured as or otherwise support a means for receiving, at the UE in a connected state, an indication to adjust the number of repetitions to be transmitted to the UE via the downlink control channel from a first number of repetitions to a second number of repetitions. The communications manager 920 may be configured as or otherwise support a means for monitoring, by the UE in the connected state, one or more TTIs for the downlink control channel based on the second number of repetitions, where a number of the one or more TTIs corresponds to the second number of repetitions.

By including or configuring the communications manager 920 in accordance with examples as described herein, the device 905 may support techniques for dynamically updating a number of repetitions for a control channel, resulting in reduced latency, reduced power consumption, more efficient utilization of communication resources, improved coordination between devices, improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of control channel adjustment for connected state as described herein, or the processor 940 and the memory 930 may be otherwise configured to perform or support such operations.

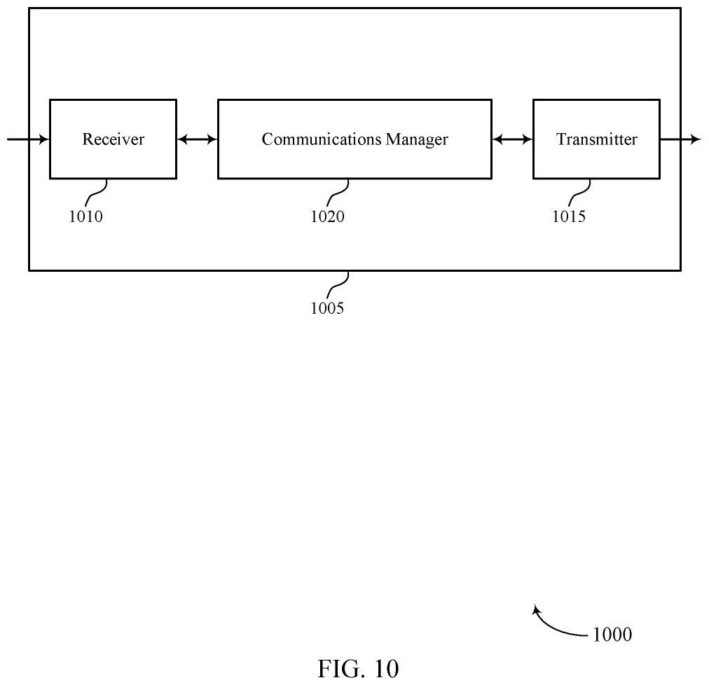

FIG. 10 shows a block diagram 1000 of a device 1005 that supports control channel adjustment for connected state in accordance with aspects of the present disclosure. The device 1005 may be an example of aspects of a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to control channel adjustment for connected state). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to control channel adjustment for connected state). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of control channel adjustment for connected state as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a base station in accordance with examples as disclosed herein. For example, the communications manager 1020 may be configured as or otherwise support a means for transmitting a control message to a UE, the control message indicating a number of repetitions for a downlink control channel for the UE. The communications manager 1020 may be configured as or otherwise support a means for transmitting, to the UE in a connected state, an indication to adjust the number of repetitions to be transmitted to the UE via the downlink control channel from a first number of repetitions to a second number of repetitions. The communications manager 1020 may be configured as or otherwise support a means for transmitting, to the UE in the connected state, the downlink control channel in one or more TTIs according to the second number of repetitions.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for dynamically updating a number of repetitions for a control channel, resulting in reduced processing, reduced power consumption, more efficient utilization of communication resources.

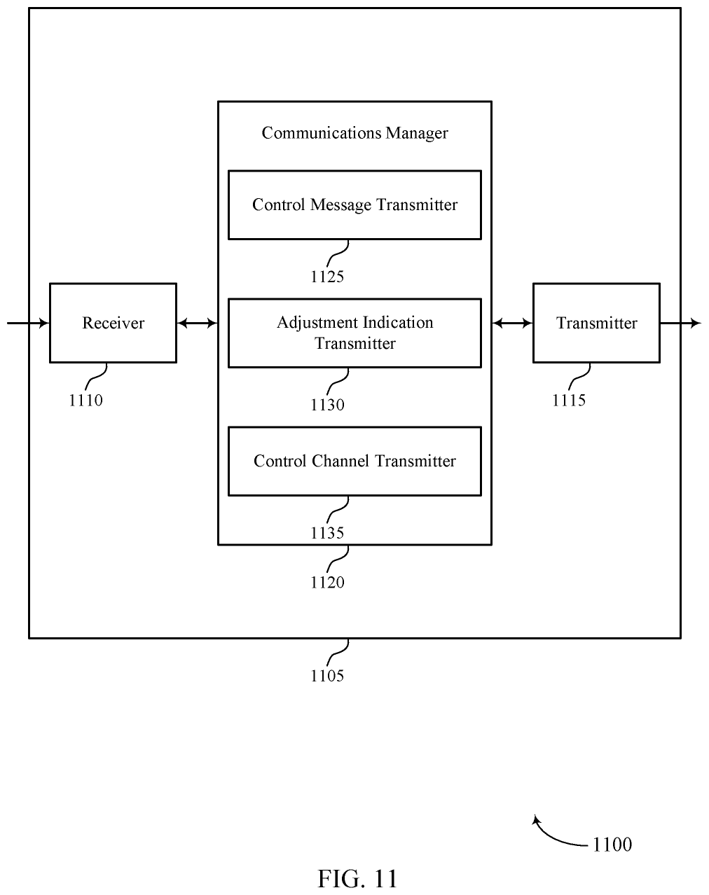

FIG. 11 shows a block diagram 1100 of a device 1105 that supports control channel adjustment for connected state in accordance with aspects of the present disclosure. The device 1105 may be an example of aspects of a device 1005 or a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to control channel adjustment for connected state). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to control channel adjustment for connected state). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of control channel adjustment for connected state as described herein. For example, the communications manager 1120 may include a control message transmitter 1125, an adjustment indication transmitter 1130, a control channel transmitter 1135, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communications at a base station in accordance with examples as disclosed herein. The control message transmitter 1125 may be configured as or otherwise support a means for transmitting a control message to a UE, the control message indicating a number of repetitions for a downlink control channel for the UE. The adjustment indication transmitter 1130 may be configured as or otherwise support a means for transmitting, to the UE in a connected state, an indication to adjust the number of repetitions to be transmitted to the UE via the downlink control channel from a first number of repetitions to a second number of repetitions. The control channel transmitter 1135 may be configured as or otherwise support a means for transmitting, to the UE in the connected state, the downlink control channel in one or more TTIs according to the second number of repetitions.

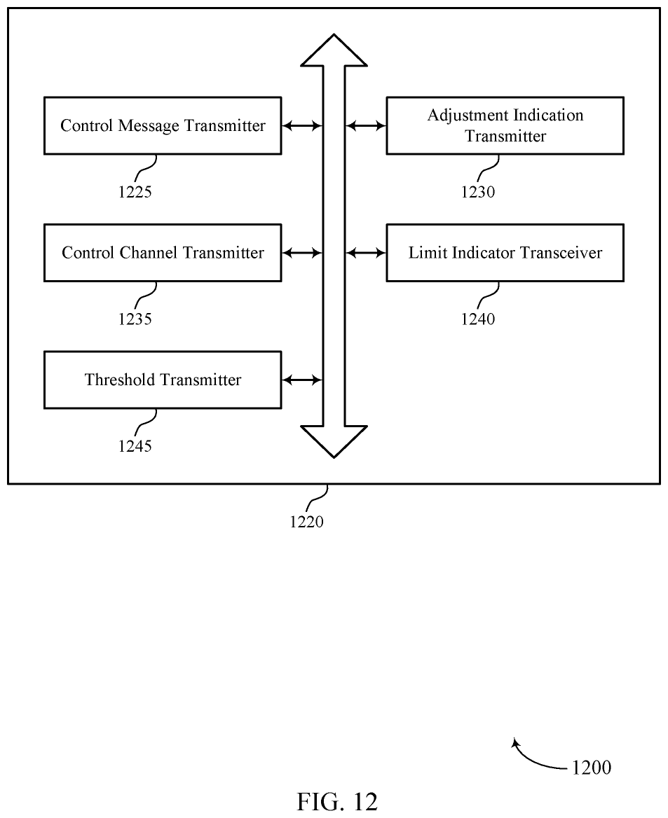

FIG. 12 shows a block diagram 1200 of a communications manager 1220 that supports control channel adjustment for connected state in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of control channel adjustment for connected state as described herein. For example, the communications manager 1220 may include a control message transmitter 1225, an adjustment indication transmitter 1230, a control channel transmitter 1235, a limit indicator transceiver 1240, a threshold transmitter 1245, or any combination thereof. Each of these components may communicate, directly or indirectly, with one another (e.g., via one or more buses).

The communications manager 1220 may support wireless communications at a base station in accordance with examples as disclosed herein. The control message transmitter 1225 may be configured as or otherwise support a means for transmitting a control message to a UE, the control message indicating a number of repetitions for a downlink control channel for the UE. The adjustment indication transmitter 1230 may be configured as or otherwise support a means for transmitting, to the UE in a connected state, an indication to adjust the number of repetitions to be transmitted to the UE via the downlink control channel from a first number of repetitions to a second number of repetitions. The control channel transmitter 1235 may be configured as or otherwise support a means for transmitting, to the UE in the connected state, the downlink control channel in one or more TTIs according to the second number of repetitions.

In some examples, the limit indicator transceiver 1240 may be configured as or otherwise support a means for receiving a limit indicator for the downlink control channel indicating that a control channel limit associated with the downlink control channel has been reached at the UE, where the indication to adjust the number of repetitions is in response to the limit indicator.

In some examples, the threshold transmitter 1245 may be configured as or otherwise support a means for transmitting, to the UE, a channel quality threshold associated with the downlink control channel, where the limit indicator is received based on a channel quality associated with the downlink control channel crossing the channel quality threshold.

In some examples, to support receiving the limit indicator, the limit indicator transceiver 1240 may be configured as or otherwise support a means for receiving the limit indicator in a control element of an uplink message, where the control element is configured for limit indicator reporting.

In some examples, the limit indicator transceiver 1240 may be configured as or otherwise support a means for transmitting the limit indicator in a control element of an uplink message, where the uplink message includes a downlink channel quality report.

In some examples, the limit indicator is a request to adjust the number of repetitions to be transmitted to the UE via the downlink control channel. In some examples, to support transmitting the indication, the adjustment indication transmitter 1230 may be configured as or otherwise support a means for transmitting the indication to adjust the number of repetitions by a step factor.

In some examples, to support transmitting the indication, the adjustment indication transmitter 1230 may be configured as or otherwise support a means for transmitting the indication to adjust the number of repetitions by a multiplication factor of the first number of repetitions. In some examples, the multiplication factor is from a set of defined multiplication factors.

In some examples, the adjustment indication transmitter 1230 may be configured as or otherwise support a means for transmitting a set of multiplication factors via broadcast signaling, where the multiplication factor is from the set of multiplication factors.

In some examples, to support transmitting the indication, the adjustment indication transmitter 1230 may be configured as or otherwise support a means for transmitting an indication to increase or decrease the number of repetitions, where the increase or decrease of the number of repetitions maintains a periodicity associated with the downlink control channel that corresponds to the first number of repetitions.

In some examples, to support transmitting the indication, the adjustment indication transmitter 1230 may be configured as or otherwise support a means for transmitting an indication to adjust a number of repetitions to be transmitted by the UE via an uplink control channel.

In some examples, to support transmitting the control message, the control message transmitter 1225 may be configured as or otherwise support a means for transmitting one or more parameters that indicate a period of the downlink control channel for the UE, the one or more parameters including a first parameter and a second parameter, the first parameter indicating the second number of repetitions to be transmitted to the UE via the downlink control channel and the second parameter indicating a starting TTI of the one or more TTIs.

In some examples, the second number of repetitions is an integer multiple of the first number of repetitions. In some examples, the control message is transmitting via RRC signaling. In some examples, the downlink control channel includes a NPDCCH.

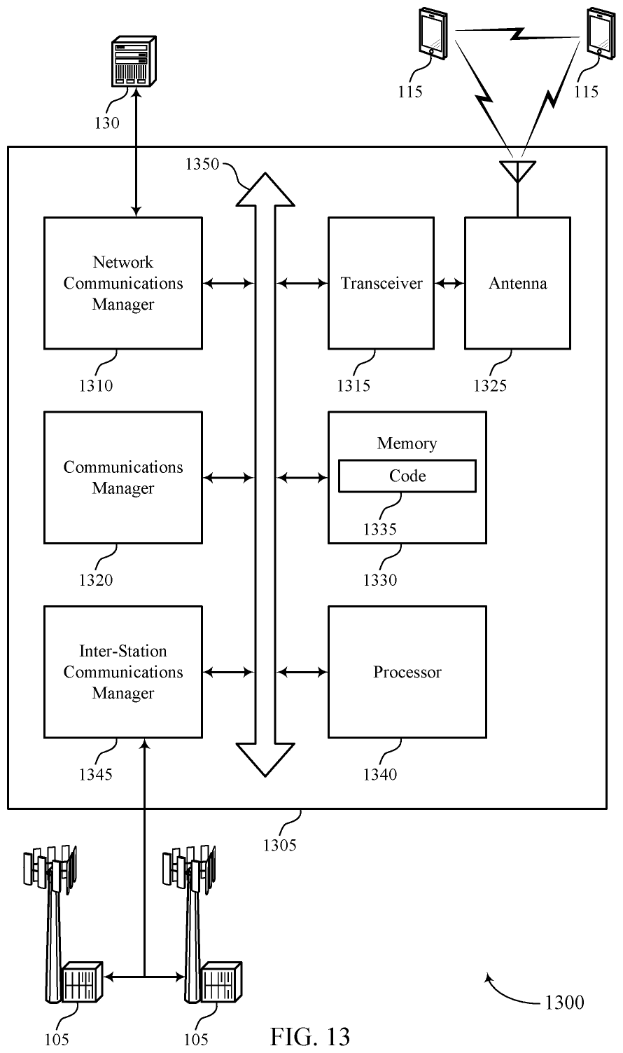

FIG. 13 shows a diagram of a system 1300 including a device 1305 that supports control channel adjustment for connected state in accordance with aspects of the present disclosure. The device 1305 may be an example of or include the components of a device 1005, a device 1105, or a base station 105 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting control channel adjustment for connected state). For example, the device 1305 or a component of the device 1305 may include a processor 1340 and memory 1330 coupled to the processor 1340, the processor 1340 and memory 1330 configured to perform various functions described herein.

The inter-station communications manager 1345 may manage communications with other base stations 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105.

The communications manager 1320 may support wireless communications at a base station in accordance with examples as disclosed herein. For example, the communications manager 1320 may be configured as or otherwise support a means for transmitting a control message to a UE, the control message indicating a number of repetitions for a downlink control channel for the UE. The communications manager 1320 may be configured as or otherwise support a means for transmitting, to the UE in a connected state, an indication to adjust the number of repetitions to be transmitted to the UE via the downlink control channel from a first number of repetitions to a second number of repetitions. The communications manager 1320 may be configured as or otherwise support a means for transmitting, to the UE in the connected state, the downlink control channel in one or more TTIs according to the second number of repetitions.

By including or configuring the communications manager 1320 in accordance with examples as described herein, the device 1305 may support techniques for dynamically updating a number of repetitions for a control channel, resulting in improved communication reliability, reduced latency, reduced power consumption, more efficient utilization of communication resources, improved coordination between devices, improved utilization of processing capability.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of control channel adjustment for connected state as described herein, or the processor 1340 and the memory 1330 may be otherwise configured to perform or support such operations.

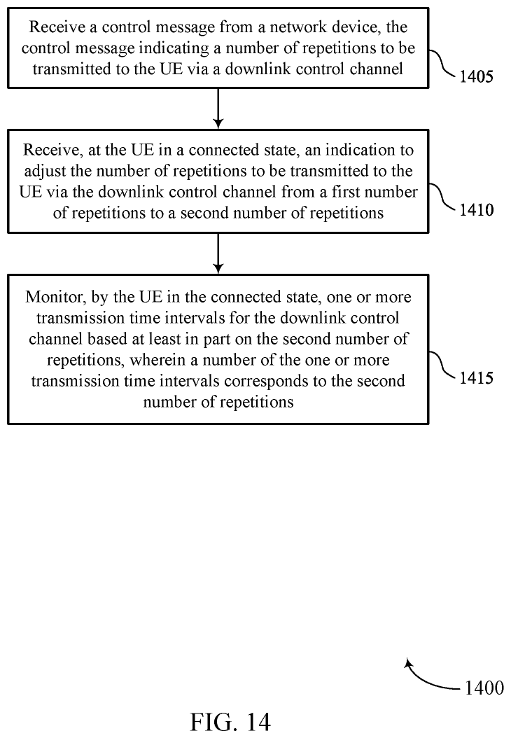

FIG. 14 shows a flowchart illustrating a method 1400 that supports control channel adjustment for connected state in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1405, the method may include receiving a control message from a network device, the control message indicating a number of repetitions to be transmitted to the UE via a downlink control channel. The operations of 1405 may be performed in accordance with examples as disclosed herein. In some examples, aspects of the operations of 1405 may be performed by a control message receiver 825 as described with reference to FIG. 8.

At 1410, the method may include receiving, at the UE in a connected state, an indication to adjust the number of repetitions to be transmitted to the UE via the downlink control channel from a first number of repetitions to a second number of repetitions. The operations of 1410 may be performed in accordance with examples as disclosed herein. In some examples, aspects of the operations of 1410 may be performed by an adjustment indication receiver 830 as described with reference to FIG. 8.

At 1415, the method may include monitoring, by the UE in the connected state, one or more TTIs for the downlink control channel based on the second number of repetitions, where a number of the one or more TTIs corresponds to the second number of repetitions. The operations of 1415 may be performed in accordance with examples as disclosed herein. In some examples, aspects of the operations of 1415 may be performed by a control channel monitoring component 835 as described with reference to FIG. 8.

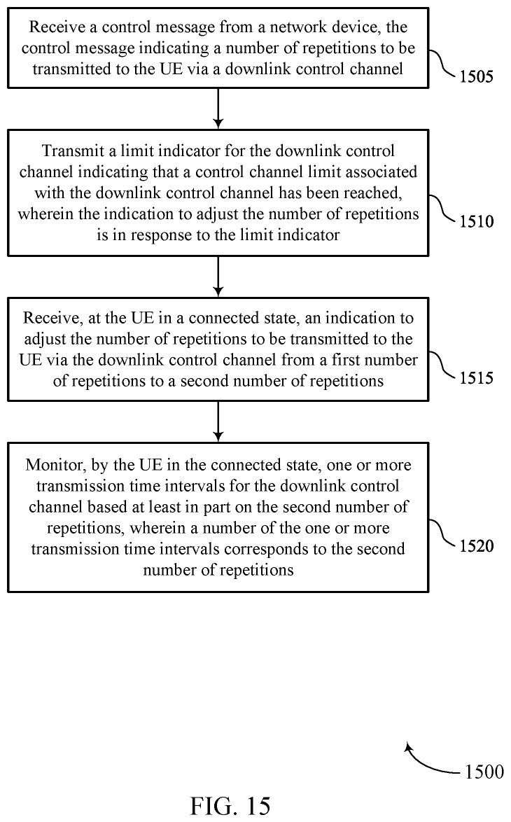

FIG. 15 shows a flowchart illustrating a method 1500 that supports control channel adjustment for connected state in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1505, the method may include receiving a control message from a network device, the control message indicating a number of repetitions to be transmitted to the UE via a downlink control channel. The operations of 1505 may be performed in accordance with examples as disclosed herein. In some examples, aspects of the operations of 1505 may be performed by a control message receiver 825 as described with reference to FIG. 8.

At 1510, the method may include transmitting a limit indicator for the downlink control channel indicating that a control channel limit associated with the downlink control channel has been reached, where the indication to adjust the number of repetitions is in response to the limit indicator. The operations of 1510 may be performed in accordance with examples as disclosed herein. In some examples, aspects of the operations of 1510 may be performed by a limit indicator transmitter 840 as described with reference to FIG. 8.

At 1515, the method may include receiving, at the UE in a connected state, an indication to adjust the number of repetitions to be transmitted to the UE via the downlink control channel from a first number of repetitions to a second number of repetitions. The operations of 1515 may be performed in accordance with examples as disclosed herein. In some examples, aspects of the operations of 1515 may be performed by an adjustment indication receiver 830 as described with reference to FIG. 8.

At 1520, the method may include monitoring, by the UE in the connected state, one or more TTIs for the downlink control channel based on the second number of repetitions, where a number of the one or more TTIs corresponds to the second number of repetitions. The operations of 1520 may be performed in accordance with examples as disclosed herein. In some examples, aspects of the operations of 1520 may be performed by a control channel monitoring component 835 as described with reference to FIG. 8.

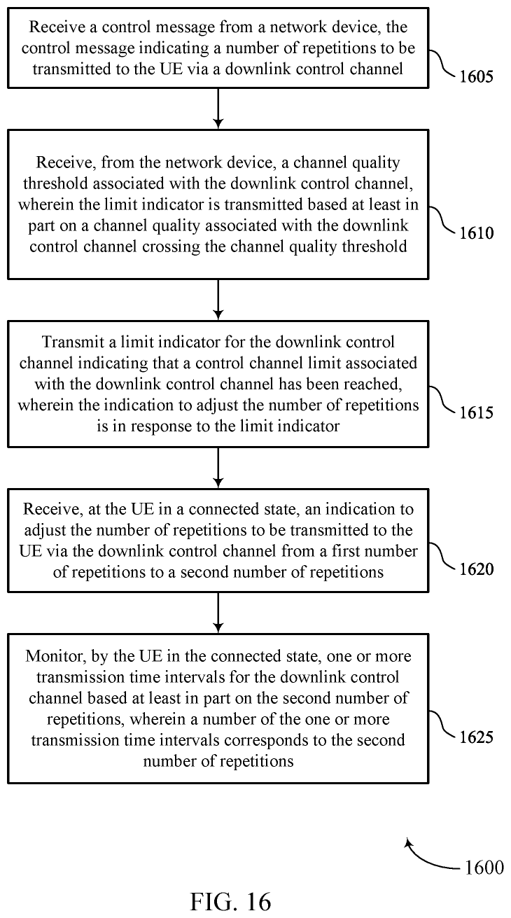

FIG. 16 shows a flowchart illustrating a method 1600 that supports control channel adjustment for connected state in accordance with aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1605, the method may include receiving a control message from a network device, the control message indicating a number of repetitions to be transmitted to the UE via a downlink control channel. The operations of 1605 may be performed in accordance with examples as disclosed herein. In some examples, aspects of the operations of 1605 may be performed by a control message receiver 825 as described with reference to FIG. 8.

At 1610, the method may include receiving, from the network device, a channel quality threshold associated with the downlink control channel, where the limit indicator is transmitted based on a channel quality associated with the downlink control channel crossing the channel quality threshold. The operations of 1610 may be performed in accordance with examples as disclosed herein. In some examples, aspects of the operations of 1610 may be performed by a threshold receiver 845 as described with reference to FIG. 8.

At 1615, the method may include transmitting a limit indicator for the downlink control channel indicating that a control channel limit associated with the downlink control channel has been reached, where the indication to adjust the number of repetitions is in response to the limit indicator. The operations of 1615 may be performed in accordance with examples as disclosed herein. In some examples, aspects of the operations of 1615 may be performed by a limit indicator transmitter 840 as described with reference to FIG. 8.

At 1620, the method may include receiving, at the UE in a connected state, an indication to adjust the number of repetitions to be transmitted to the UE via the downlink control channel from a first number of repetitions to a second number of repetitions. The operations of 1620 may be performed in accordance with examples as disclosed herein. In some examples, aspects of the operations of 1620 may be performed by an adjustment indication receiver 830 as described with reference to FIG. 8.

At 1625, the method may include monitoring, by the UE in the connected state, one or more TTIs for the downlink control channel based on the second number of repetitions, where a number of the one or more TTIs corresponds to the second number of repetitions. The operations of 1625 may be performed in accordance with examples as disclosed herein. In some examples, aspects of the operations of 1625 may be performed by a control channel monitoring component 835 as described with reference to FIG. 8.

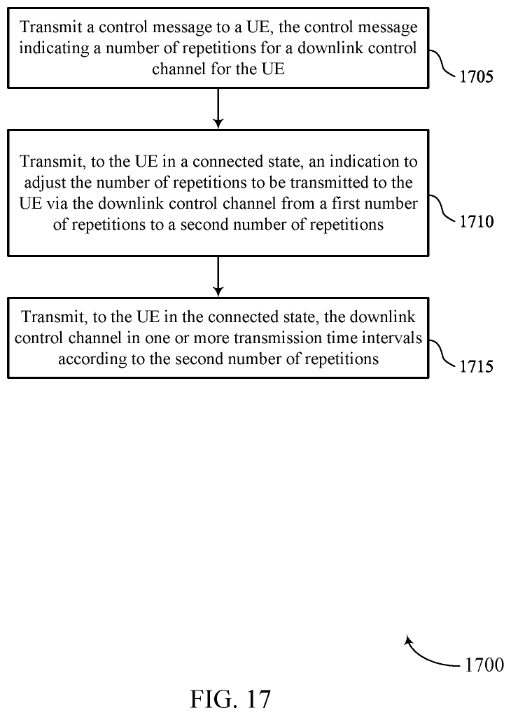

FIG. 17 shows a flowchart illustrating a method 1700 that supports control channel adjustment for connected state in accordance with aspects of the present disclosure. The operations of the method 1700 may be implemented by a network device or its components as described herein. For example, the operations of the method 1700 may be performed by a network device 105 as described with reference to FIGS. 1 through 5 and 10 through 13. In some examples, a network device may execute a set of instructions to control the functional elements of the network device to perform the described functions. Additionally or alternatively, the network device may perform aspects of the described functions using special-purpose hardware.

At 1705, the method may include transmitting a control message to a UE, the control message indicating a number of repetitions for a downlink control channel for the UE. The operations of 1705 may be performed in accordance with examples as disclosed herein. In some examples, aspects of the operations of 1705 may be performed by a control message transmitter 1225 as described with reference to FIG. 12.

At 1710, the method may include transmitting, to the UE in a connected state, an indication to adjust the number of repetitions to be transmitted to the UE via the downlink control channel from a first number of repetitions to a second number of repetitions. The operations of 1710 may be performed in accordance with examples as disclosed herein. In some examples, aspects of the operations of 1710 may be performed by an adjustment indication transmitter 1230 as described with reference to FIG. 12.

At 1715, the method may include transmitting, to the UE in the connected state, the downlink control channel in one or more TTIs according to the second number of repetitions. The operations of 1715 may be performed in accordance with examples as disclosed herein. In some examples, aspects of the operations of 1715 may be performed by a control channel transmitter 1235 as described with reference to FIG. 12.

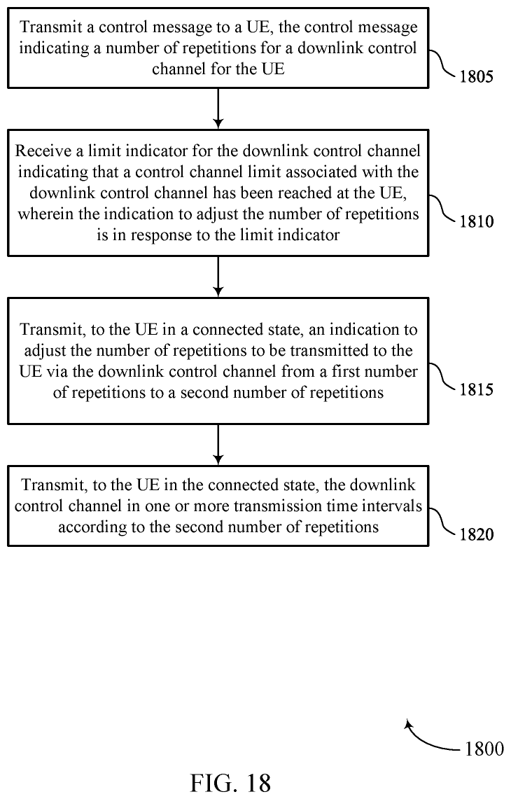

FIG. 18 shows a flowchart illustrating a method 1800 that supports control channel adjustment for connected state in accordance with aspects of the present disclosure. The operations of the method 1800 may be implemented by a network device or its components as described herein. For example, the operations of the method 1800 may be performed by a network device 105 as described with reference to FIGS. 1 through 5 and 10 through 13. In some examples, a network device may execute a set of instructions to control the functional elements of the network device to perform the described functions. Additionally or alternatively, the network device may perform aspects of the described functions using special-purpose hardware.

At 1805, the method may include transmitting a control message to a UE, the control message indicating a number of repetitions for a downlink control channel for the UE. The operations of 1805 may be performed in accordance with examples as disclosed herein. In some examples, aspects of the operations of 1805 may be performed by a control message transmitter 1225 as described with reference to FIG. 12.

At 1810, the method may include receiving a limit indicator for the downlink control channel indicating that a control channel limit associated with the downlink control channel has been reached at the UE, where the indication to adjust the number of repetitions is in response to the limit indicator. The operations of 1810 may be performed in accordance with examples as disclosed herein. In some examples, aspects of the operations of 1810 may be performed by a limit indicator transceiver 1240 as described with reference to FIG. 12.

At 1815, the method may include transmitting, to the UE in a connected state, an indication to adjust the number of repetitions to be transmitted to the UE via the downlink control channel from a first number of repetitions to a second number of repetitions. The operations of 1815 may be performed in accordance with examples as disclosed herein. In some examples, aspects of the operations of 1815 may be performed by an adjustment indication transmitter 1230 as described with reference to FIG. 12.

At 1820, the method may include transmitting, to the UE in the connected state, the downlink control channel in one or more TTIs according to the second number of repetitions. The operations of 1820 may be performed in accordance with examples as disclosed herein. In some examples, aspects of the operations of 1820 may be performed by a control channel transmitter 1235 as described with reference to FIG. 12.

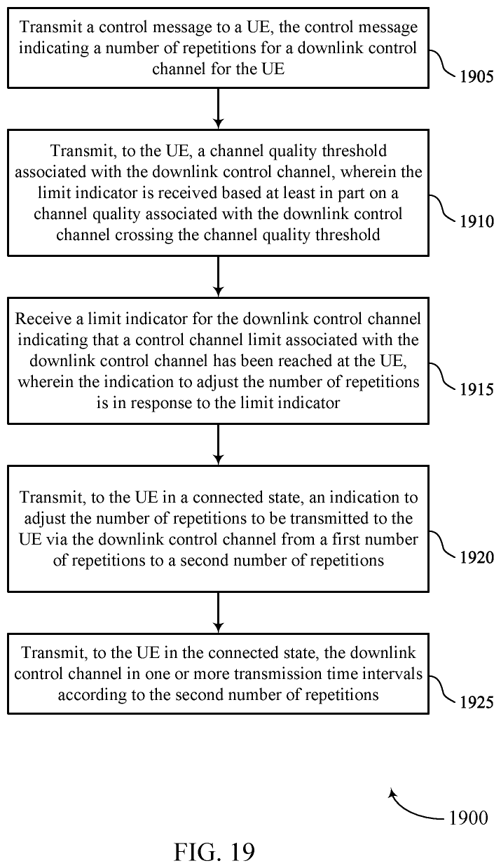

FIG. 19 shows a flowchart illustrating a method 1900 that supports control channel adjustment for connected state in accordance with aspects of the present disclosure. The operations of the method 1900 may be implemented by a network device or its components as described herein. For example, the operations of the method 1900 may be performed by a network device 105 as described with reference to FIGS. 1 through 5 and 10 through 13. In some examples, a network device may execute a set of instructions to control the functional elements of the network device to perform the described functions. Additionally or alternatively, the network device may perform aspects of the described functions using special-purpose hardware.

At 1905, the method may include transmitting a control message to a UE, the control message indicating a number of repetitions for a downlink control channel for the UE. The operations of 1905 may be performed in accordance with examples as disclosed herein. In some examples, aspects of the operations of 1905 may be performed by a control message transmitter 1225 as described with reference to FIG. 12.

At 1910, the method may include transmitting, to the UE, a channel quality threshold associated with the downlink control channel, where the limit indicator is received based on a channel quality associated with the downlink control channel crossing the channel quality threshold. The operations of 1910 may be performed in accordance with examples as disclosed herein. In some examples, aspects of the operations of 1910 may be performed by a threshold transmitter 1245 as described with reference to FIG. 12.

At 1915, the method may include receiving the limit indicator in a control element of an uplink message, where the control element is configured for limit indicator reporting or the uplink message is associated with downlink channel quality reporting. The operations of 1915 may be performed in accordance with examples as disclosed herein. In some examples, aspects of the operations of 1915 may be performed by a limit indicator transceiver 1240 as described with reference to FIG. 12.

At 1920, the method may include transmitting, to the UE in a connected state, an indication to adjust the number of repetitions to be transmitted to the UE via the downlink control channel from a first number of repetitions to a second number of repetitions. The operations of 1920 may be performed in accordance with examples as disclosed herein. In some examples, aspects of the operations of 1920 may be performed by an adjustment indication transmitter 1230 as described with reference to FIG. 12.

At 1925, the method may include transmitting, to the UE in the connected state, the downlink control channel in one or more TTIs according to the second number of repetitions. The operations of 1925 may be performed in accordance with examples as disclosed herein. In some examples, aspects of the operations of 1925 may be performed by a control channel transmitter 1235 as described with reference to FIG. 12.

The following provides an overview of aspects of the present disclosure:

Aspect 1: A method for wireless communications at a UE, comprising: receiving a control message from a network device, the control message indicating a number of repetitions to be transmitted to the UE via a downlink control channel; receiving, at the UE in a connected state, an indication to adjust the number of repetitions to be transmitted to the UE via the downlink control channel from a first number of repetitions to a second number of repetitions; and monitoring, by the UE in the connected state, one or more transmission time intervals for the downlink control channel based at least in part on the second number of repetitions, wherein a number of the one or more transmission time intervals corresponds to the second number of repetitions.

Aspect 2: The method of aspect 1, further comprising: transmitting a limit indicator for the downlink control channel indicating that a control channel limit associated with the downlink control channel has been reached, wherein the indication to adjust the number of repetitions is in response to the limit indicator.

Aspect 3: The method of aspect 2, further comprising: receiving, from the network device, a channel quality threshold associated with the downlink control channel, wherein the limit indicator is transmitted based at least in part on a channel quality associated with the downlink control channel crossing the channel quality threshold.

Aspect 4: The method of any of aspects 2 through 3, wherein transmitting the limit indicator comprises: transmitting the limit indicator in a control element of an uplink message, wherein the control element is configured for limit indicator reporting.

Aspect 5: The method of any of aspects 2 through 4, wherein transmitting the limit indicator comprises: transmitting the limit indicator in a control element of an uplink message, wherein the uplink message comprises a downlink channel quality report.

Aspect 6: The method of any of aspects 2 through 5, wherein the limit indicator is a request to adjust the number of repetitions to be transmitted to the UE via the downlink control channel.

Aspect 7: The method of any of aspects 1 through 6, wherein receiving the indication comprises: receiving the indication to adjust the number of repetitions by a step factor.

Aspect 8: The method of any of aspects 1 through 7, wherein receiving the indication comprises: receiving the indication to adjust the number of repetitions by a multiplication factor of the first number of repetitions.

Aspect 9: The method of aspect 8, wherein the multiplication factor is from a set of defined multiplication factors.

Aspect 10: The method of any of aspects 8 through 9, wherein the multiplication factor is from a set of multiplication factors received via broadcast signaling.

Aspect 11: The method of any of aspects 1 through 10, wherein receiving the indication comprises: receiving the indication to increase or decrease the number of repetitions, wherein the increase or decrease of the number of repetitions maintains a periodicity associated with the downlink control channel that corresponds to the first number of repetitions.

Aspect 12: The method of any of aspects 1 through 11, wherein receiving the indication comprises: receiving the indication to adjust the number of repetitions to be transmitted by the UE via an uplink control channel.

Aspect 13: The method of any of aspects 1 through 12, wherein receiving the control message comprises: receiving one or more parameters that indicate a period of the downlink control channel for the UE, the one or more parameters comprising a first parameter and a second parameter, the first parameter indicating the second number of repetitions to be transmitted to the UE via the downlink control channel and the second parameter indicating a starting transmission time interval of the one or more transmission time intervals.

Aspect 14: The method of any of aspects 1 through 13, wherein the second number of repetitions is an integer multiple of the first number of repetitions.

Aspect 15: The method of any of aspects 1 through 14, wherein the control message is received via radio resource control signaling; and the downlink control channel comprises a physical downlink control channel.

Aspect 16: A method for wireless communications at a network device, comprising: transmitting a control message to a UE, the control message indicating a number of repetitions for a downlink control channel for the UE; transmitting, to the UE in a connected state, an indication to adjust the number of repetitions to be transmitted to the UE via the downlink control channel from a first number of repetitions to a second number of repetitions; and transmitting, to the UE in the connected state, the downlink control channel in one or more transmission time intervals according to the second number of repetitions.

Aspect 17: The method of aspect 16, further comprising: receiving a limit indicator for the downlink control channel indicating that a control channel limit associated with the downlink control channel has been reached at the UE, wherein the indication to adjust the number of repetitions is in response to the limit indicator.

Aspect 18: The method of aspect 17, further comprising: transmitting, to the UE, a channel quality threshold associated with the downlink control channel, wherein the limit indicator is received based at least in part on a channel quality associated with the downlink control channel crossing the channel quality threshold.

Aspect 19: The method of any of aspects 17 through 18, wherein receiving the limit indicator comprises: receiving the limit indicator in a control element of an uplink message, wherein the control element is configured for limit indicator reporting.

Aspect 20: The method of aspect 19, further comprising: transmitting the limit indicator in a control element of an uplink message, wherein the uplink message comprises a downlink channel quality report.

Aspect 21: The method of any of aspects 17 through 20, wherein the limit indicator is a request to adjust the number of repetitions to be transmitted to the UE via the downlink control channel.

Aspect 22: The method of any of aspects 16 through 21, wherein transmitting the indication comprises: transmitting the indication to adjust the number of repetitions by a step factor.

Aspect 23: The method of any of aspects 16 through 22, wherein transmitting the indication comprises: transmitting the indication to adjust the number of repetitions by a multiplication factor of the first number of repetitions.

Aspect 24: The method of aspect 23, further comprising: transmitting a set of multiplication factors via broadcast signaling, wherein the multiplication factor is from the set of multiplication factors.

Aspect 25: The method of any of aspects 16 through 24, wherein transmitting the indication comprises: transmitting the indication to increase or decrease the number of repetitions, wherein the increase or decrease of the number of repetitions maintains a periodicity associated with the downlink control channel that corresponds to the first number of repetitions.

Aspect 26: The method of any of aspects 16 through 25, wherein transmitting the indication comprises: transmitting the indication to adjust the number of repetitions to be transmitted by the UE via an uplink control channel.

Aspect 27: The method of any of aspects 16 through 26, wherein transmitting the control message comprises: transmitting one or more parameters that indicate a period of the downlink control channel for the UE, the one or more parameters comprising a first parameter and a second parameter, the first parameter indicating the second number of repetitions to be transmitted to the UE via the downlink control channel and the second parameter indicating a starting transmission time interval of the one or more transmission time intervals.

Aspect 28: The method of any of aspects 16 through 27, wherein the second number of repetitions is an integer multiple of the first number of repetitions.

Aspect 29: An apparatus for wireless communications at a UE, comprising a processor; memory coupled with the processor; and instructions stored in the memory and executable by the processor to cause the apparatus to perform a method of any of aspects 1 through 15.

Aspect 30: An apparatus for wireless communications at a UE, comprising at least one means for performing a method of any of aspects 1 through 15.

Aspect 31: A non-transitory computer-readable medium storing code for wireless communications at a UE, the code comprising instructions executable by a processor to perform a method of any of aspects 1 through 15.

Aspect 32: An apparatus for wireless communications at a network device, comprising a processor; memory coupled with the processor; and instructions stored in the memory and executable by the processor to cause the apparatus to perform a method of any of aspects 16 through 28.

Aspect 33: An apparatus for wireless communications at a network device, comprising at least one means for performing a method of any of aspects 16 through 28.

Aspect 34: A non-transitory computer-readable medium storing code for wireless communications at a network device, the code comprising instructions executable by a processor to perform a method of any of aspects 16 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, or any combination thereof. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving a control message from a network device, the control message indicating a number of repetitions to be transmitted to the UE via a downlink control channel;
receiving, at the UE in a connected state, an indication to adjust the number of repetitions to be transmitted to the UE via the downlink control channel from a first number of repetitions to a second number of repetitions; and
monitoring, by the UE in the connected state, one or more transmission time intervals for the downlink control channel based at least in part on the second number of repetitions, wherein a number of the one or more transmission time intervals corresponds to the second number of repetitions.

2. The method of claim 1, further comprising:
transmitting a limit indicator for the downlink control channel indicating that a control channel limit associated with the downlink control channel has been reached, wherein the indication to adjust the number of repetitions is in response to the limit indicator.

3. The method of claim 2, further comprising:
receiving, from the network device, a channel quality threshold associated with the downlink control channel, wherein the limit indicator is transmitted based at least in part on a channel quality associated with the downlink control channel crossing the channel quality threshold.

4. The method of claim 2, wherein transmitting the limit indicator comprises:
transmitting the limit indicator in a control element of an uplink message, wherein the control element is configured for limit indicator reporting.

5. The method of claim 2, wherein transmitting the limit indicator comprises:
transmitting the limit indicator in a control element of an uplink message, wherein the uplink message comprises a downlink channel quality report.

6. The method of claim 2, wherein the limit indicator is a request to adjust the number of repetitions to be transmitted to the UE via the downlink control channel.

7. The method of claim 1, wherein receiving the indication comprises:
receiving the indication to adjust the number of repetitions by a step factor.

8. The method of claim 1, wherein receiving the indication comprises:
receiving the indication to adjust the number of repetitions by a multiplication factor of the first number of repetitions.

9. The method of claim 8, wherein the multiplication factor is from a set of defined multiplication factors.

10. The method of claim 8, wherein the multiplication factor is from a set of multiplication factors received via broadcast signaling.

11. The method of claim 1, wherein receiving the indication comprises:
receiving the indication to increase or decrease the number of repetitions, wherein the increase or decrease of the number of repetitions maintains a periodicity associated with the downlink control channel that corresponds to the first number of repetitions.

12. The method of claim 1, wherein receiving the indication comprises:
receiving the indication to adjust the number of repetitions to be transmitted by the UE via an uplink control channel.

13. The method of claim 1, wherein receiving the control message comprises:
receiving one or more parameters that indicate a period of the downlink control channel for the UE, the one or more parameters comprising a first parameter and a second parameter, the first parameter indicating the second number of repetitions to be transmitted to the UE via the downlink control channel and the second parameter indicating a starting transmission time interval of the one or more transmission time intervals.

14. The method of claim 1, wherein the second number of repetitions is an integer multiple of the first number of repetitions.

15. The method of claim 1, wherein:
the control message is received via radio resource control signaling; and
the downlink control channel comprises a physical downlink control channel.

16. A method for wireless communications at a network device, comprising:
transmitting a control message to a user equipment (UE), the control message indicating a number of repetitions for a downlink control channel for the UE;
transmitting, to the UE in a connected state, an indication to adjust the number of repetitions to be transmitted to the UE via the downlink control channel from a first number of repetitions to a second number of repetitions; and
transmitting, to the UE in the connected state, the downlink control channel in one or more transmission time intervals according to the second number of repetitions.

17. The method of claim 16, further comprising:
receiving a limit indicator for the downlink control channel indicating that a control channel limit associated with the downlink control channel has been reached at the UE, wherein the indication to adjust the number of repetitions is in response to the limit indicator.

18. The method of claim 17, further comprising:
transmitting, to the UE, a channel quality threshold associated with the downlink control channel, wherein the limit indicator is received based at least in part on a channel quality associated with the downlink control channel crossing the channel quality threshold.

19. The method of claim 17, wherein receiving the limit indicator comprises:
receiving the limit indicator in a control element of an uplink message, wherein the control element is configured for limit indicator reporting.

20. The method of claim 17, further comprising:
transmitting the limit indicator in a control element of an uplink message, wherein the uplink message comprises a downlink channel quality report.

21. The method of claim 17, wherein the limit indicator is a request to adjust the number of repetitions to be transmitted to the UE via the downlink control channel.

22. The method of claim 16, wherein transmitting the indication comprises:
transmitting the indication to adjust the number of repetitions by a step factor.

23. The method of claim 16, wherein transmitting the indication comprises:
transmitting the indication to adjust the number of repetitions by a multiplication factor of the first number of repetitions.

24. The method of claim 23, further comprising:
transmitting a set of multiplication factors via broadcast signaling, wherein the multiplication factor is from the set of multiplication factors.

25. The method of claim 16, wherein transmitting the indication comprises:
transmitting the indication to increase or decrease the number of repetitions, wherein the increase or decrease of the number of repetitions maintains a periodicity associated with the downlink control channel that corresponds to the first number of repetitions.

26. The method of claim 16, wherein transmitting the indication comprises:
transmitting the indication to adjust the number of repetitions to be transmitted by the UE via an uplink control channel.

27. The method of claim 16, wherein transmitting the control message comprises:
transmitting one or more parameters that indicate a period of the downlink control channel for the UE, the one or more parameters comprising a first parameter and a second parameter, the first parameter indicating the second number of repetitions to be transmitted to the UE via the downlink control channel and the second parameter indicating a starting transmission time interval of the one or more transmission time intervals.

28. The method of claim 16, wherein the second number of repetitions is an integer multiple of the first number of repetitions.

29. An apparatus for wireless communications at a user equipment (UE), comprising:
a processor;
memory coupled with the processor; and
instructions stored in the memory and executable by the processor to cause the UE to:
receive a control message from a network device, the control message indicating a number of repetitions to be transmitted to the UE via a downlink control channel;
receive, at the UE in a connected state, an indication to adjust the number of repetitions to be transmitted to the UE via the downlink control channel from a first number of repetitions to a second number of repetitions; and
monitor, by the UE in the connected state, one or more transmission time intervals for the downlink control channel based at least in part on the second number of repetitions, wherein a number of the one or more transmission time intervals corresponds to the second number of repetitions.

30. An apparatus for wireless communications at a network device, comprising:
a processor;
memory coupled with the processor; and
instructions stored in the memory and executable by the processor to cause the network device to:
transmit a control message to a user equipment (UE), the control message indicating a number of repetitions for a downlink control channel for the UE;
transmit, to the UE in a connected state, an indication to adjust the number of repetitions to be transmitted to the UE via the downlink control channel from a first number of repetitions to a second number of repetitions; and
transmit, to the UE in the connected state, the downlink control channel in one or more transmission time intervals according to the second number of repetitions.
